(19) United States
(12) Patent Application Publication
(10) Pub. No.: US 2022/0180215 A1
(43) Pub. Date: Jun. 9, 2022

(54) SYSTEM AND COMPUTER NETWORK FOR KNOWLEDGE SEARCH AND ANALYSIS

(71) Applicant: Nitin Kumar, Stanford, CA (US)

(72) Inventor: Nitin Kumar, Stanford, CA (US)

(21) Appl. No.: 17/540,209

(22) Filed: Dec. 1, 2021

Related U.S. Application Data
(60) Provisional application No. 63/122,529, filed on Dec. 8, 2020.

(51) Int. Cl. G06N 5/02; G06F 16/953; G06F 40/58; G06F 16/93

(52) U.S. Cl. CPC G06N 5/02; G06F 16/93; G06F 40/58; G06F 16/953

(57) ABSTRACT

Described herein are technologies for overcoming technical problems associated with implementing a system for search and analysis of technical information over a computer network. For example, described herein are systems and methods for overcoming technical problems associated with implementing a system for search and analysis of scientific and engineering studies data over a computer network. With respect to some embodiments, described herein are technologies leveraging computer networking and a software architecture to overcome technical problems associated with implementing search and analysis systems for technical information.

### CROSS-REFERENCE TO RELATED APPLICATIONS

The present application claims the benefit of priority from U.S. Provisional Patent Application No. 63/122,529, filed on Dec. 8, 2020, and entitled “A SYSTEM FOR SCIENTIFIC AND ENGINEERING KNOWLEDGE SEARCH AND ANALYSIS”, the entire disclosure of which application is hereby incorporated herein by reference.

### TECHNICAL FIELD

The present disclosure relates to systems and computer networks for knowledge search and analysis. For example, the present disclosure relates to systems and computer networks for scientific and engineering knowledge search and analysis.

### BACKGROUND

Knowledge search and knowledge analysis with artificial intelligence technologies is growing. Artificial intelligence (AI) is intelligence executed by machines such as machines including computing systems. This is instead of natural intelligence which is demonstrated by animals including humans. AI applications include web search engines, recommendation systems, speech recognition, self-driving cars, automated decision-making.

As of yet, AI systems have not been effectively implemented in a computer network to improve upon or overcome several technical problems in scientific and engineering knowledge search and analysis. Some of such technical problems may not be included in this disclosure and others are described herein.

### SUMMARY

Described herein are technologies for overcoming technical problems associated with implementing a system for search and analysis of technical information over a computer network. For example, described herein are systems and methods for overcoming technical problems associated with implementing a system for search and analysis of scientific and engineering studies data over a computer network. With respect to some embodiments, described herein are technologies leveraging computer networking and a software architecture to overcome technical problems associated with implementing search and analysis systems for technical information.

In summary, the systems and methods (or techniques) disclosed herein can provide specific technical solutions to at least overcome the technical problems mentioned in the background section and other parts of the application as well as other technical problems not described herein but recognized by those skilled in the art.

With respect to some embodiments, disclosed herein are computerized methods for implementing search and analysis of technical information over a computer network, as well as a non-transitory computer-readable storage medium for carrying out technical operations of the computerized methods. The non-transitory computer-readable storage medium has tangibly stored thereon, or tangibly encoded thereon, computer readable instructions that when executed by one or more devices (e.g., one or more personal computers or servers) cause at least one processor to perform a method of search and analysis of technical information over a computer network.

With respect to some embodiments, a system is provided that includes at least one computing device configured to provide search and analysis of technical information over a computer network. And, with respect to some embodiments, a method is provided to be performed by at least one computing device. In some example embodiments, computer program code can be executed by at least one processor of one or more computing devices to implement functionality in accordance with at least some embodiments described herein; and the computer program code being at least a part of or stored in a non-transitory computer-readable medium.

These and other important aspects of the invention are described more fully in the detailed description below. The invention is not limited to the particular assemblies, apparatuses, methods and systems described herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various embodiments of the disclosure. It is to be understood that the accompanying drawings presented are intended for the purpose of illustration and not intended to restrict the disclosure.

FIG. 1 illustrates an example computer network of computer systems to implement technologies for some of the systems, methods, and platforms described herein, in accordance with some embodiments of the present disclosure.

FIG. 2 illustrates is a block diagram of example aspects of an example computer system, in accordance with some embodiments of the present disclosure.

FIG. 3 shows complex and varied types of data, documents, images, plots, videos, etc. that are used by scientists and engineers to make decisions, which can be used as input in any one of the systems or methods described herein.

FIG. 4 shows a system to combine all types of knowledge contents, including scientific and engineering knowledge contents, and an overview of the system, in accordance with some embodiments of the present disclosure.

FIG. 5 shows complex and large variety of data and information analyzed by engineers and scientists, which can be used as input in accordance with some embodiments of the present disclosure. Also, FIG. 5 shows aspects of a knowledge search and analysis engine, in accordance with some embodiments of the present disclosure.

FIG. 6 shows a system to combine the knowledge contents including an organization's internal and external knowledge, in accordance with some embodiments of the present disclosure.

FIG. 7 shows a single point search (or a one click search) for scientific data, in accordance with some embodiments of the present disclosure.

FIG. 8 shows results of a single point search, in accordance with some embodiments of the present disclosure.

FIG. 9 shows results of a single point search such as results including a dataset (experimental, production data, etc.), images, images from documents, images from data, and a knowledge graph, in accordance with some embodiments of the present disclosure.

FIG. 10 shows results of video and audio contents, which are results of a single point search, in accordance with some embodiments of the present disclosure.

FIG. 11 shows views of various knowledge contents extracted from a document, in accordance with some embodiments of the present disclosure.

FIG. 12 shows documents, images, papers, patents and other knowledge contents related to a document, in accordance with some embodiments of the present disclosure.

FIG. 13 shows a combining different types of data, plots, images, etc. to create a unified dataset with data obtained from R&D, production, IoT devices, etc., in accordance with some embodiments of the present disclosure.

FIG. 14 shows image and image similarity search results, in accordance with some embodiments of the present disclosure.

FIG. 15 shows knowledge graph search results, in accordance with some embodiments of the present disclosure.

FIG. 16 shows an on-demand translation of a full user screen page, in accordance with some embodiments of the present disclosure.

FIG. 17 shows an on-demand translation of selected text, in accordance with some embodiments of the present disclosure.

FIGS. 18 and 19 show an overview of a knowledge extraction process, in accordance with some embodiments of the present disclosure.

FIG. 20 shows extraction of structured data from various types of files, including documents, IoT files, databases, etc., in accordance with some embodiments of the present disclosure.

FIG. 21 shows extraction of text from documents, images and texts, in accordance with some embodiments of the present disclosure.

FIG. 22 shows extraction of concepts and knowledge entities from text using computer-implemented language processing and language understanding, in accordance with some embodiments of the present disclosure.

FIG. 23 shows a process of creation of a knowledge graph, in accordance with some embodiments of the present disclosure. New relationships are created among various knowledge entitles and knowledge contents by analyzing multiple factors, including entity frequencies, entity locations, number, distances in each document, number of documents, entity types. Knowledge graph is configured to automatically create new relationships and update strength of existing relationships when a new document or entity is added. The search and analysis of knowledge graphs are used to answer users' questions.

FIG. 24 shows processing of Internet of Thing (IOT) components and instrument data files as well as identification of events and abnormal measurements, in accordance with some embodiments of the present disclosure.

FIG. 25 shows spectral similarity, in accordance with some embodiments of the present disclosure.

FIG. 26 shows a process of calculating spectral similarity, in accordance with some embodiments of the present disclosure.

FIG. 27 shows documents and images' textual similarity, in accordance with some embodiments of the present disclosure.

FIG. 28 shows web pages, papers and patents, and domain specific contents, and a related computer-implemented process, in accordance with some embodiments of the present disclosure.

FIG. 29 shows an image visual similarity process, in accordance with some embodiments of the present disclosure.

FIG. 30 shows multiple ways to enter search terms for a one click search into an organization's internal knowledge, external knowledge, and user private data, in accordance with some embodiments of the present disclosure.

FIG. 31 shows a process of a magic search, in accordance with some embodiments of the present disclosure.

FIG. 32 shows examples of a magic search, in accordance with some embodiments of the present disclosure.

FIG. 33 shows a flow diagram of a magic search, in accordance with some embodiments of the present disclosure.

FIG. 34 shows multiple ways for users to provide search information, in accordance with some embodiments of the present disclosure.

FIGS. 35 to 48 show processes and aspects of understanding the user's intent and procedures and workflows of the user intent engine, in accordance with some embodiments of the present disclosure.

FIGS. 49 to 51 show an overall architecture of a knowledge search and analysis platform, in accordance with some embodiments of the present disclosure.

FIGS. 52 to 55 show an implementation of the one click (i.e., single point) knowledge platform and use of its libraries, in accordance with some embodiments of the present disclosure.

FIGS. 56 to 60 show various types of search options available to library users of the platform, in accordance with some embodiments of the present disclosure.

FIGS. 61 to 63 show various search results from a library knowledge search and analysis engine, in accordance with some embodiments of the present disclosure.

FIG. 64 shows a feature that allows users to load their own document, in accordance with some embodiments of the present disclosure.

FIG. 65 shows a hybrid content recommendation engine, in accordance with some embodiments of the present disclosure.

FIG. 66 shows a procedure to use various types of information, in accordance with some embodiments of the present disclosure.

FIG. 67 shows a use case of the one click knowledge search and analysis platform, for scientist and engineers in the pharmaceutical field as well as doctors and other professionals in healthcare, in accordance with some embodiments of the present disclosure.

FIG. 68 shows a pharma and medical knowledge analysis platform, in accordance with some embodiments of the present disclosure.

FIG. 69 shows customizations of a core platform, in accordance with some embodiments of the present disclosure.

FIG. 70 shows how different public knowledge sources, including structured data, unstructured data, documents, HTML pages images, and videos are (i) combined together, (ii) extract knowledge contents and entities as described in FIGS. 6 to 19, (iii) creation of a medical knowledge graph, and (iv) implementation of various knowledge search and analysis features, in accordance with some embodiments of the present disclosure.

FIGS. 71 to 75 show various types of pharma and medical knowledge searches, in accordance with some embodiments of the present disclosure.

FIG. 76 shows a global scientific and engineering knowledge platform based on the core knowledge search analysis platform, in accordance with some embodiments of the present disclosure.

FIG. 77 shows how the global knowledge platform can have multiple knowledge platforms specific to the needs of individual domains, in accordance with some embodiments of the present disclosure.

FIG. 78 shows the addition of a discussion feature in the knowledge platform, in accordance with some embodiments of the present disclosure.

FIG. 79 shows two examples of a discussion forum and feature on a dataset view page and document view page, in accordance with some embodiments of the present disclosure.

### DETAILED DESCRIPTION

Described herein are systems and methods for overcoming technical problems associated with implementing a system for search and analysis of technical information over a computer network. For example, described herein are systems and methods for overcoming technical problems associated with implementing a system for search and analysis of scientific and engineering studies data over a computer network. With respect to some embodiments, described herein are systems and methods leveraging computer networking and a software architecture to overcome technical problems associated with implementing search and analysis systems.

In general, companies and organizations have very large amounts of knowledge and information in many different formats, file and types. Among them, the scientific and engineering knowledge is one of the most complex types of information to retrieve and analyze. Company, university and organization employees spend significant amount of time manually searching and analyzing data from different sources.

Disclosed herein are technologies for knowledge search and discovery, as well as technologies including or being a part of a knowledge analysis platform using many new processes and technologies including artificial intelligence, big data technologies, etc. A goal of the platforms described herein is to automate knowledge search and analysis for companies, organizations, universities, professionals, students, doctors, etc. While the platforms described herein focus on scientific, engineering, and medical knowledge search and analysis, such platforms can be used for other fields and domains, including fields such as art, history, geography, legal, finance, etc. Scientific, engineering, and medical knowledge is one of the most complex knowledgebases with a large variety and amount of data, data types, and file types. The knowledge platforms described herein have been designed for the large variety of data types, sources and complexity of scientific and engineering knowledge and analysis. Therefore, the platforms can be used for other domains and industries.

Another objective of the technologies described herein is to create an electronic system that centralizes various types of files containing different types of scientific, engineering, and medical knowledge. These files and documents and knowledge could be generated internally by a company, university, organization or an individual. The disclosure describes the design and the procedure to build the electronic system to centralize, organize, and analyze all internal and external scientific and engineering literature and document generated internally by the company, university, organization or by and individual, or generated externally by others in form of papers, patents, books, websites, and other types of content available on the web. The platforms also combine internal and external knowledge to provide a one click and one place cognitive knowledge search and analysis.

In some embodiments, a knowledge search and analysis platform uses various artificial intelligence and machine learning technologies to analyze and understand the contents of hundreds to millions of documents, images, sounds, videos, etc. The platforms extract information from such documents and data. Also, analysis bots of one of the platforms can be custom designed to search and analyze the information and knowledge. User can also write custom machine learning programs to use the extracted data and information for making machine-driven decision making.

In this application, for example, described is the details of a knowledge search and analysis platform, various knowledge extraction procedures, knowledge analysis, and knowledge similarity features. Descriptions of such technologies are also found in the drawings of this application. Described and shown are multiple implementations of the knowledge platform for specific domains. This includes pharma and medical domain, implementation of knowledge platform for libraries, and implementation of the knowledge platform for global scientific, engineering and scholarly knowledge.

The following detailed description provides detailed implementations on the platforms. The description includes an illustration of a single point one click search for an organization's knowledge, including scientific and engineering knowledge and data. Also, described herein is a system to combine an organization's internal and external knowledge, including scientific and engineering knowledge as well as a system for visualizing scientific and engineering data for experiment and production data in a single user interface. Also, described herein is a process to extract knowledge entities from unstructured text, structured text, and images, as well as a machine reading entity search and a magic search. Also, described herein is an intent search to understand users' intent and provide/recommend user the specific results from specific sources. Described herein is also the creation of an evolving and self-learning knowledge graph as well as spectral similarity features to identify patterns in plots, spectral, X-Y and IOT data. Also, described herein is hybrid content recommendation, ranking and decision-making as well as a core system including a knowledge search and analysis platform with one click cognitive search into an organization's libraries, internal and external contents. Also, described herein is a pharma and medical knowledge search and analysis platform combining pharmaceutical and medical information and data from various sources. Such a platform is designed for everyone involved in the pharma and medical industries from researchers/scientist, manufacturing engineers, salespeople, physicians, and patients. Also, described herein is a system for global scientific knowledge search and analysis using as a data source publicly available literature.

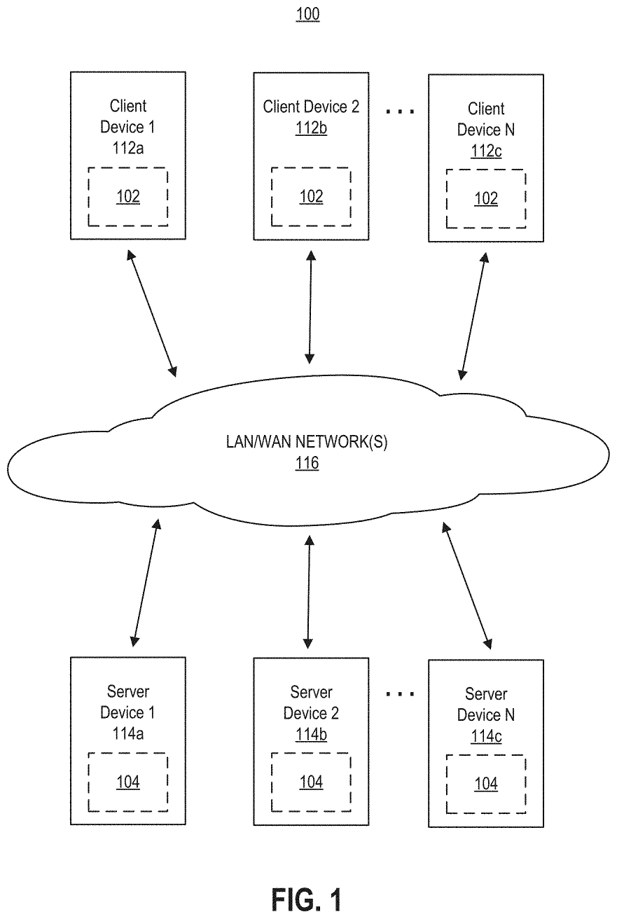

FIG. 1 illustrates an example computer network 100 of computer systems to implement technologies for a search and analysis system (e.g., any one of the platforms described herein). Such a search and analysis system includes a system frontend 102 and a system backend 104. The computer network 100 can implement any of the operations, modules, engines, or other types of components of the systems described herein. Also, the computer network 100 is shown including client devices (e.g., see client devices 112a, 112b, and 112c). And, as shown, the system frontend 102 can be hosted and executed on the client devices of the computer network 100. The computer network 100 is also shown including server devices (e.g., see server devices 114a, 114b, and 114c). And, as shown, the system backend 104 can be hosted and executed on the server devices of the computer network 100. Also, the computer network 100 is shown including one or more LAN/WAN networks 116 which is shown communicatively coupling the server devices hosting the system backend 104 and the client devices hosting the system frontend 102. The LAN/WAN network(s) 116 can include one or more local area networks (LAN(s)) and/or one or more wide area networks (WAN(s)). The LAN/WAN network(s) 116 can include the Internet and/or any other type of interconnected communications network. The LAN/WAN network(s) 116 can also include a single computer network or a telecommunications network. More specifically, the LAN/WAN network(s) 116 can include a local area network (LAN) such as a private computer network that connects computers in small physical areas, a wide area network (WAN) to connect computers located in different geographical locations, and/or a metropolitan area network (MAN)—also known as a middle area network—to connect computers in a geographic area larger than that covered by a large LAN but smaller than the area covered by a WAN.

At least each shown component of the computer network 100 can be or include a computer system which can include memory that can include media. The media can include or be volatile memory components, non-volatile memory components, or a combination of such. In general, each of the computer systems can include a host system that uses the memory. For example, the host system can write data to the memory and read data from the memory. The host system can be a computing device such as a desktop computer, laptop computer, network server, mobile device, or such computing device that includes a memory and a processing device. The host system can include or be coupled to the memory so that the host system can read data from or write data to the memory. The host system can be coupled to the memory via a physical host interface. The physical host interface can provide an interface for passing control, address, data, and other signals between the memory and the host system.

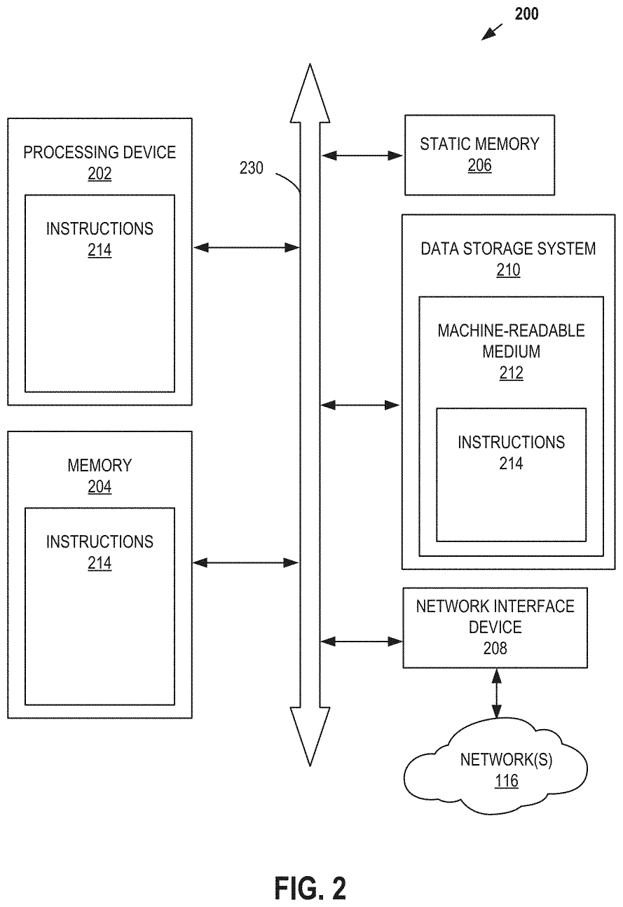

FIG. 2 illustrates is a block diagram of example aspects of an example computing system 200, in accordance with some embodiments of the present disclosure. FIG. 2 illustrates parts of the computing system 200 within which a set of instructions, for causing a machine of the computing system 200 to perform any one or more of the methodologies discussed herein or shown in the drawings, can be executed. In some embodiments, the computing system 200 can correspond to a host system that includes, is coupled to, or utilizes memory or can be used to perform the operations of a controller (e.g., to execute an operating system to perform operations corresponding to any one of the client or server devices shown in FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein or shown in the drawings.

The computing system 200 includes a processing device 202, a main memory 204 (e.g., read-only memory (ROM), flash memory, dynamic random-access memory (DRAM), etc.), a static memory 206 (e.g., flash memory, static random-access memory (SRAM), etc.), and a data storage system 210, which communicate with each other via a bus 230.

The processing device 202 represents one or more general-purpose processing devices such as a microprocessor, a central processing unit, or the like. More particularly, the processing device can be a microprocessor or a processor implementing other instruction sets, or processors implementing a combination of instruction sets. The processing device 202 can also be one or more special-purpose processing devices such as an application specific integrated circuit (ASIC), a field programmable gate array (FPGA), a digital signal processor (DSP), network processor, or the like. The processing device 202 is configured to execute instructions 214 for performing the operations discussed herein or shown in the drawings. The computing system 200 can further include a network interface device 208 to communicate over the LAN/WAN network(s) 116 of FIG. 1.

The data storage system 210 can include a machine-readable storage medium 212 (also known as a computer-readable medium) on which is stored one or more sets of instructions 214 or software embodying any one or more of the methodologies or functions described herein or shown in the drawings. The instructions 214 can also reside, completely or at least partially, within the main memory 204 and/or within the processing device 202 during execution thereof by the computing system 200, the main memory 204 and the processing device 202 also constituting machine-readable storage media.

In one embodiment, the instructions 214 include instructions to implement functionality corresponding to the client devices and server devices shown in FIG. 1 (e.g., see system frontend 102 and system backend 104 shown in FIG. 1). While the machine-readable storage medium 212 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

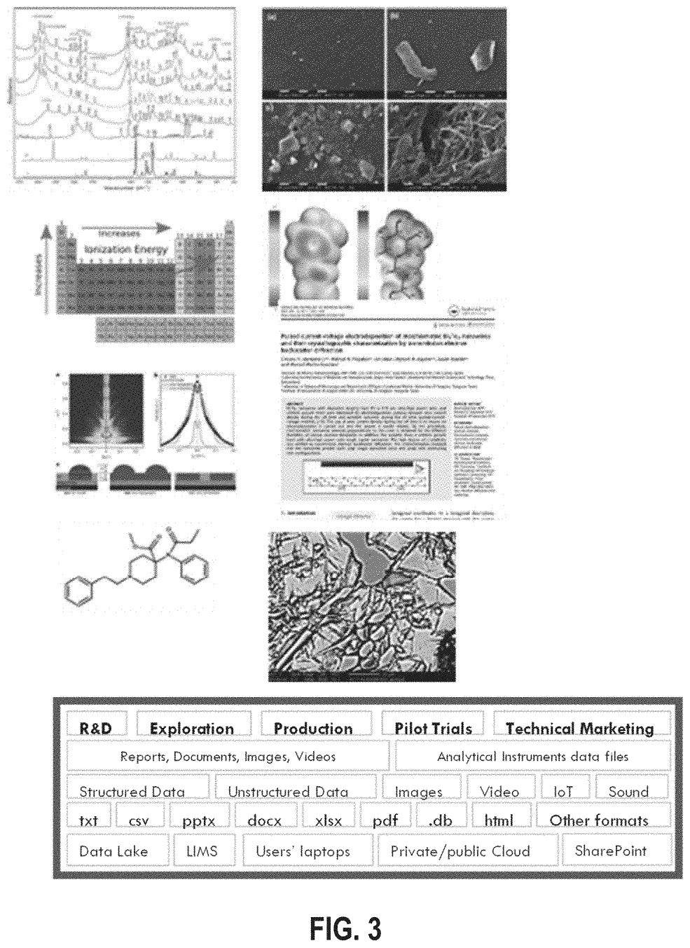

FIG. 3 shows complex and varied types of data, documents, images, plots, videos, etc. that are used by scientists and engineers to make decisions, which can be used as input in any one of the systems or methods described herein. This is beneficial to scientists and engineers that have to search and analyze many different types of files and data sources.

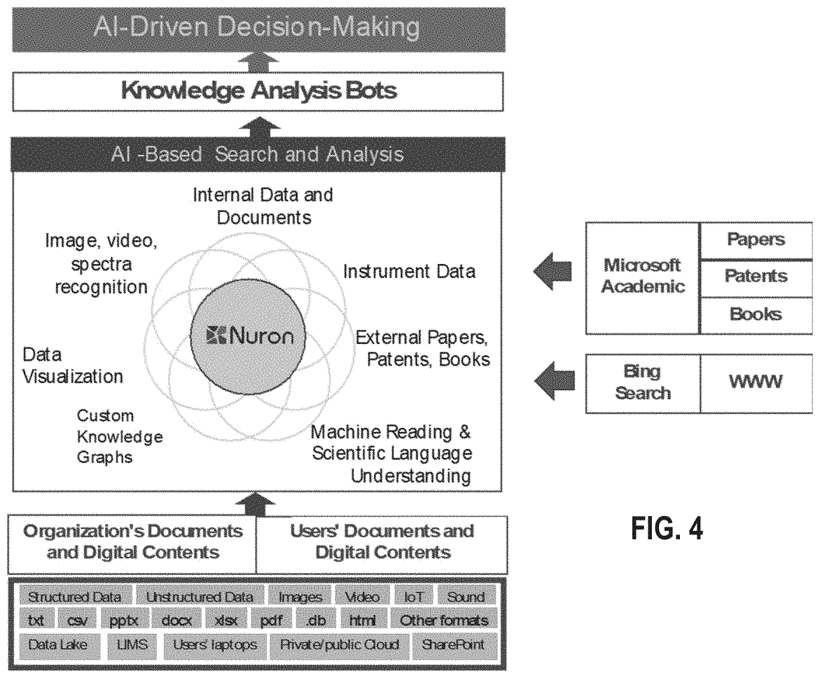

FIG. 4 shows a system to combine all types of knowledge contents, including scientific and engineering knowledge contents, and an overview of the system. FIG. 4 illustrates a system to combine all types of knowledge contents, including scientific and engineering knowledge contents. FIG. 4 also shows how, in some embodiments, a knowledge platform extracts organizations and users' knowledge contents from various types of files and combines such information with other external sources of knowledge, such as papers, patents, books, internet websites, etc. Various features of the platform are shown in FIG. 4 that allow the cognitive search into the contents of the knowledge. In some embodiments, knowledge analysis bots are custom bots that help to automate specific knowledge search and analysis workflows. Also, users, companies, and organizations can build their own machine learning programs that use the custom designed bots to analyze the knowledge and information to make machine-driven decisions.

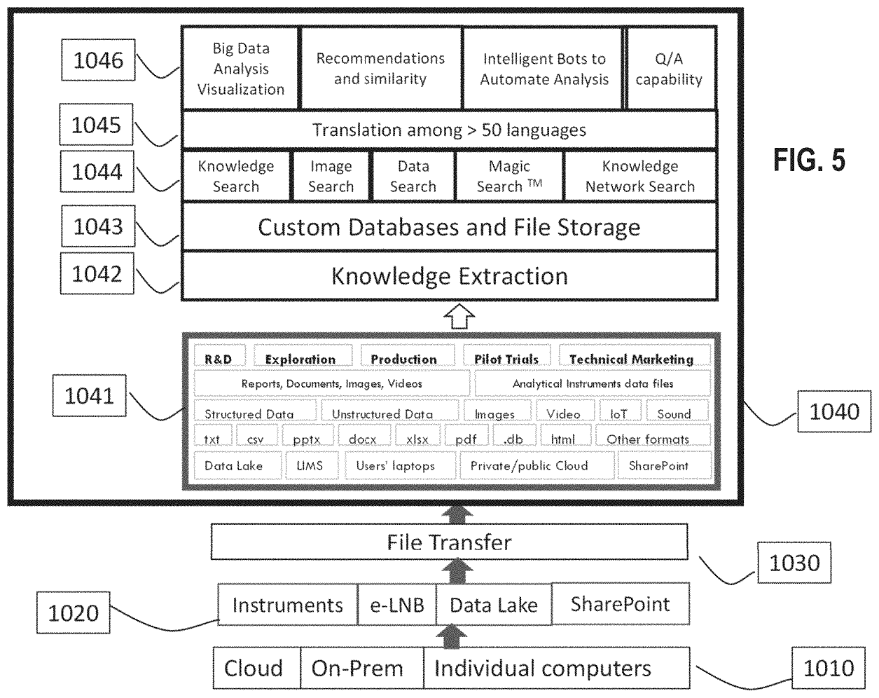

FIG. 5 shows complex and large variety of data and information analyzed by engineers and scientists, which can be used as input in accordance with some embodiments of the present disclosure. Also, FIG. 5 shows aspects of a knowledge search and analysis engine. The knowledge search and analysis engine includes many components, as shown in box 1040. Various types of files containing scientific and engineering information for different types of organizations are shown as being included in the engine, in box 1040. These files are stored in cloud infrastructure, on-prem data centers, or on individual computers (see box 1010). These files can also be stored in other systems, such as data lake, Electronic notebooks etcetera (see box 1020). These files are transferred into the knowledge search and analysis engine by various types of file transfer (see box 1030). The file transfer can be done by manually loading files into a user interface or by automatically transferring the files by other means, such though HTML, FTP, or cloud transfer, etc. box 1042 represents a knowledge extraction feature that extracts various types of contents from files, such as text, images, structured data, numbers, sounds, etc. box 1042 also has various artificial intelligence-based features. All the extracted knowledge contents are stored in various types of databases, and file storage systems, as shown in box 1043. The knowledge insight search features use various types of modules, cognitive text search, image search, structured data search, magic search, and knowledge graph search. A translation feature allows users to convert text among multiple languages (box 1045). The analysis modules (box 1046) combine various types of data visualization and features for the search modules (box 1044) to help build custom analysis modules that can automate the analysis for users.

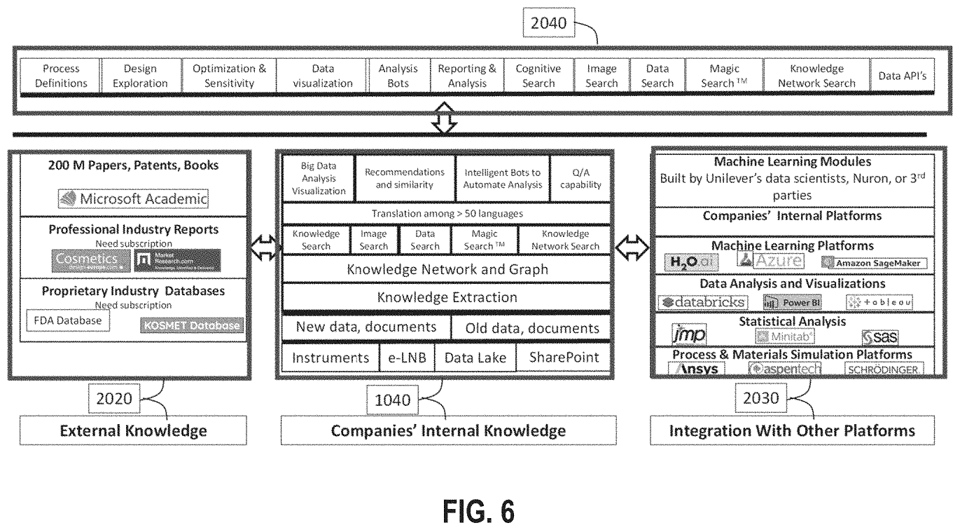

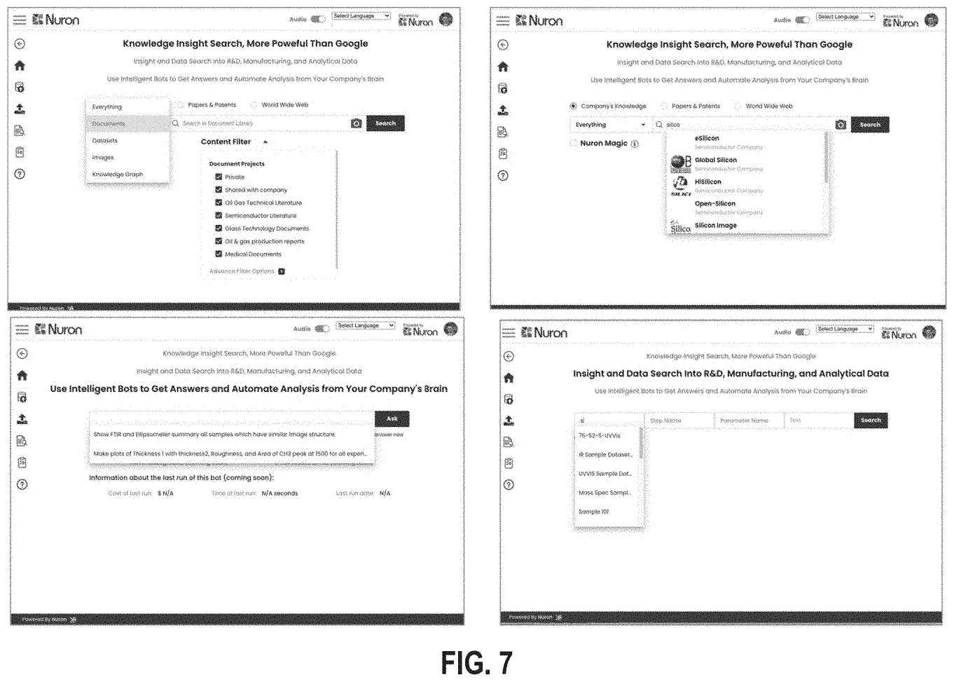

FIG. 6 shows a system to combine the knowledge contents including an organization's internal and external knowledge. The system connects a company's, an organization's, or a university's internal knowledge with external knowledge. Box 1040 is described in FIG. 5 and shown in FIG. 6. An organization's internal data is connected to external data (box 2020). External data and knowledge could be in form of repository of patents, and papers, industry report databases, industry specific databases, FDA databases, etc. The external knowledge sources (box 2020) are connected to the knowledge system (1040) through data API's and other data transfer methods. The knowledge system can also connect with other platforms, such as an organization's own internal platforms, machine learning modules, commercial data analysis modules, statistical analysis modules, and simulation/modeling software (box 2030). Box 2040 represents many modules through which the user will access an organization's internal knowledge, external knowledge and data/information from other platforms integrated with the knowledge system. FIG. 6 shows various components of the system that connects an organization's internal knowledge, external knowledge and other specialized platforms. An organization's internal data and document is processed as described in FIG. 5. The unified system interface (2040) allows searching and analysis of knowledge contents with various methods, such the methods describe herein. The unified user interface allow users to search for an organization's internal contents, external contents (papers, patents, and other industry specific databases) from one single interface. The unified interface allows a one click search into all knowledge contents and knowledge types including documents, papers patents, image, data sounds, videos, etc. Example of this interface is shown in FIG. 7.

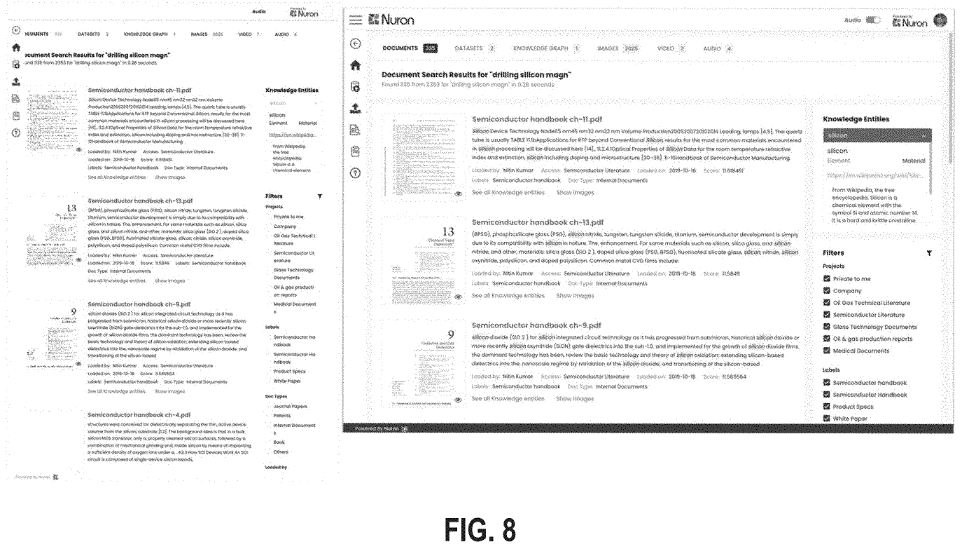

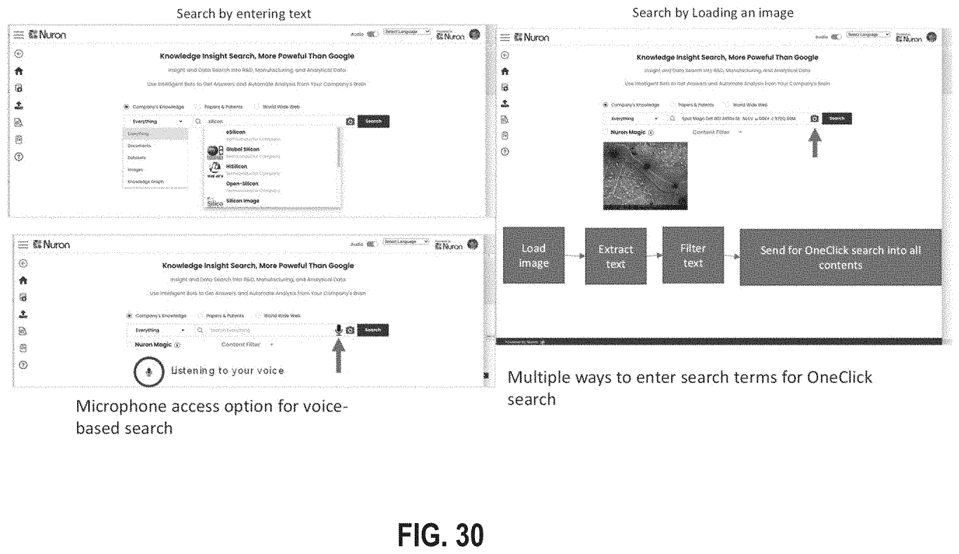

FIG. 7 shows a single point search (i.e., one click search) for scientific data. FIG. 7 shows one example version of a unified interface to search for extracted knowledge and information. The knowledge content search results could be from an organization's internal contents, or external public contents, or specialized databases and industry specific sources. FIG. 7 shows a cognitive search module shown in FIG. 6. This is an example use case for a company which has internal documents, data, and where users search for external knowledge contents and internal contents at the same time. The cognitive capabilities can identify the search word type and present appropriate information. FIG. 8 shows the search results of one the interfaces shown in FIG. 7. User can also load and image rather than enter the text or speak the search terms. More options are described in FIG. 30.

FIG. 8 shows results of a single point search (i.e., a one click search). FIG. 8 shows the one click cognitive search results from document, images, knowledge graph, and other sources from the interface shown in FIG. 7. This can be modified and customized to show selected or additional results from various sources. In one interface, the user can see different types of content results from a company's internal and external knowledge sources. This includes, documents, datasets, images. Also, FIG. 8 shows an image search module as shown in FIG. 6.

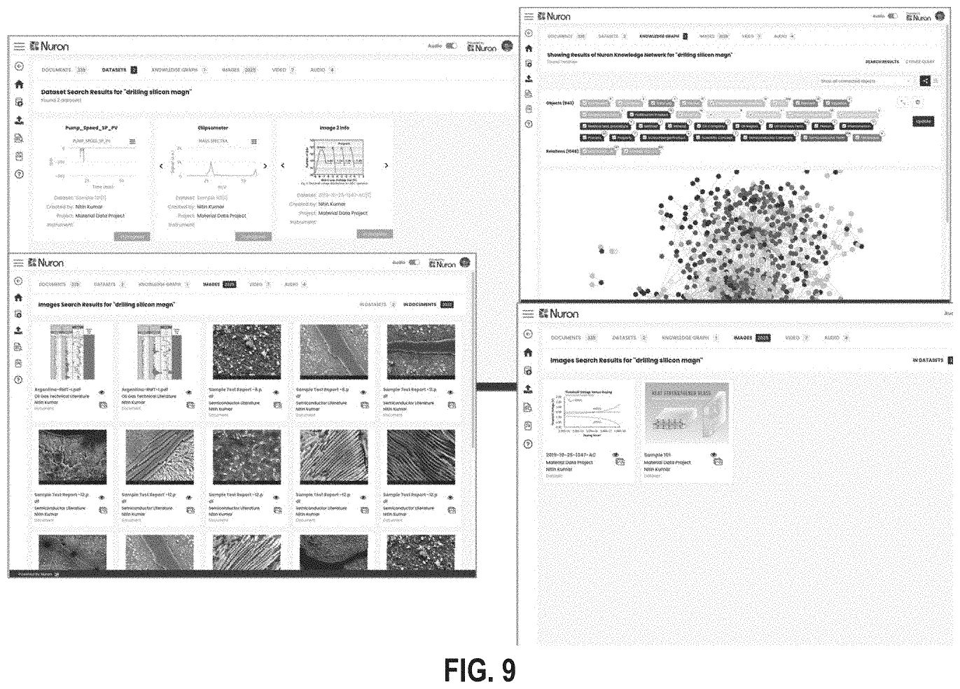

FIG. 9 shows results of a single point search such as results including a dataset (experimental, production data, etc.), images, images from documents, images from data, and a knowledge graph. FIG. 9 shows the results of image search in documents, image search in datasets, dataset search, and knowledge graph search results.

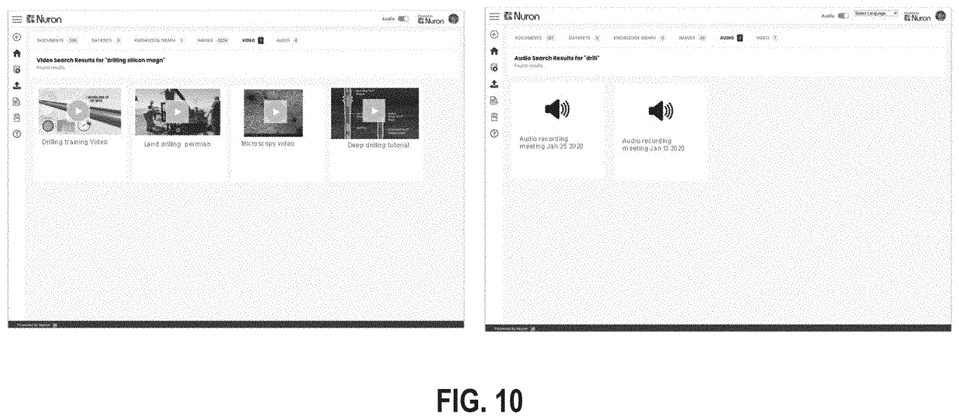

FIG. 10 shows results of video and audio contents, which are results of a single point search. In other words, FIG. 10 shows one click search results for audio and video contents.

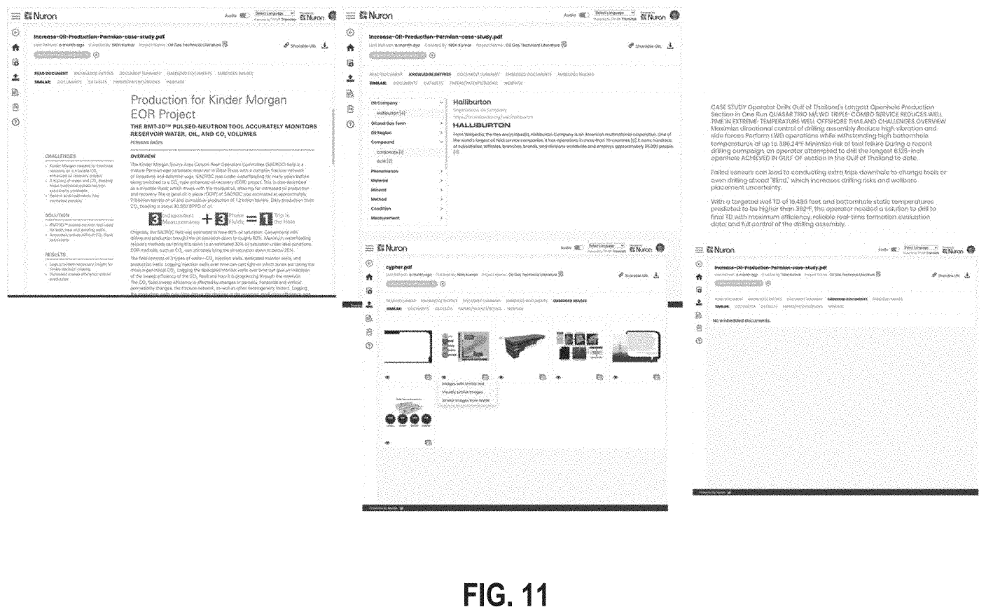

FIG. 11 shows views of various knowledge contents extracted from a document. FIG. 11 shows the details of search results from various document results as well. Also, FIG. 11 shows various knowledge contents, images, etc. extracted from a document. In the single interface, a user can read the contents of the document, view knowledge concepts and entities in the document, statistics of the knowledge entities, images in the document, document summary, and other embedded documents within the document.

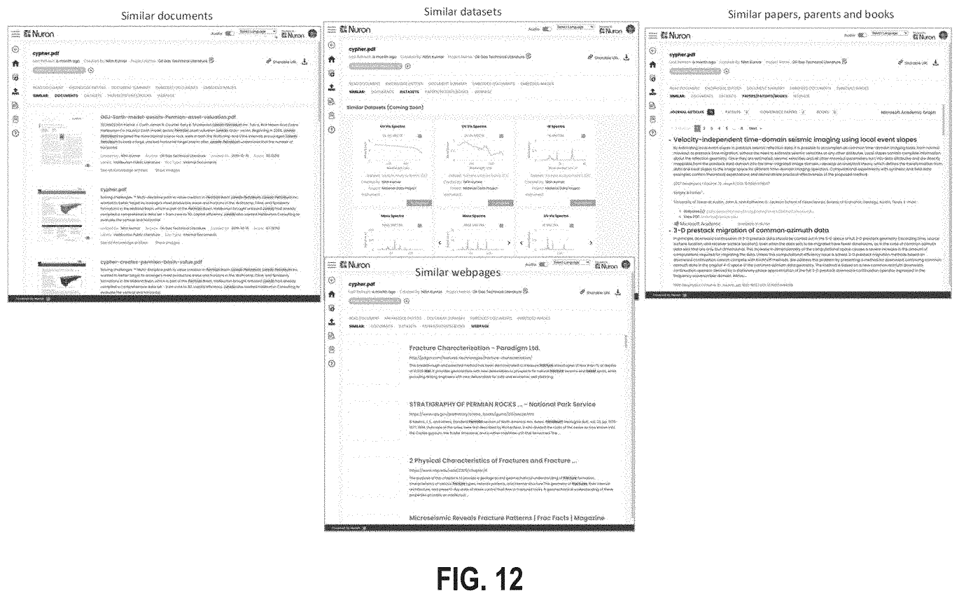

FIG. 12 shows documents, images, papers, patents and other knowledge contents related to a document, such as the document referred to in the description of FIG. 11. FIG. 12 shows various similarity features, as shown in FIG. 6. The knowledge analysis platform shows knowledge entities and concepts extracted from the document. The process of knowledge extraction and similarity calculations is described in more detail in other drawings of this disclosure. FIG. 6 also shows how the knowledge platform also suggests external knowledge in the form of papers, patents, and books. It also recommends if there are other companies internal R&D and production data that is similar to the document being viewed.

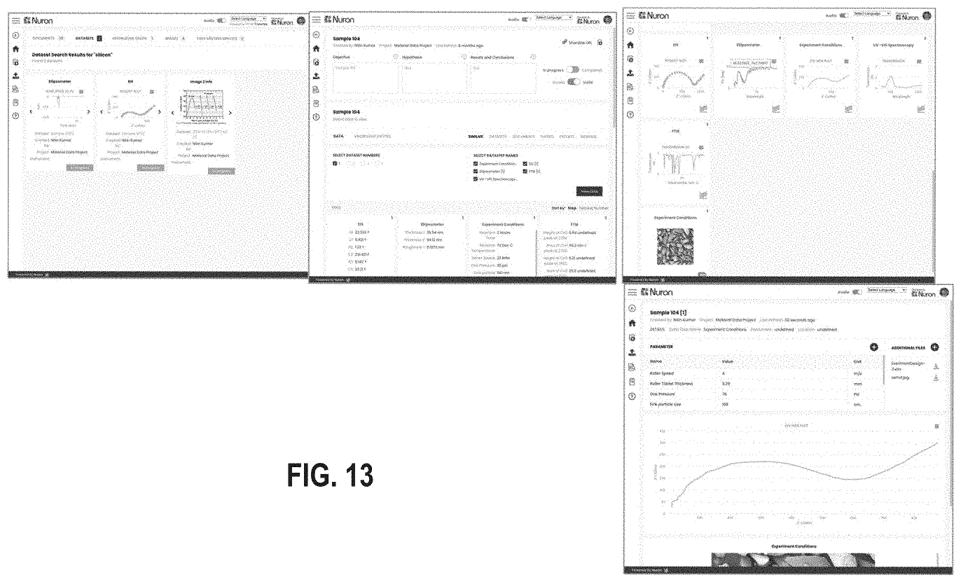

FIG. 13 shows a combining different types of data, plots, images, etc. to create a unified dataset with data obtained from R&D, production, IoT devices, etc., in accordance with some embodiments of the present disclosure. FIG. 13 shows the datasets search results from the search query shown in FIG. 7. The knowledge analysis platform converts R&D, production and other types of data into interactive data and allows users to get a view of data for the same experiment from all or most related sources. From the original instrument files, reports, data files, IoT data files, various data is extracted. The system creates plots and calculates various statistical values. Images, videos, and sound data are also processed and collected. Data from various instruments, experiments etc. are combined with some unique identifier, such as experiment number or batch number. In this manner, the platform analyzes different types and variety of data, analyzes the data, and provides a user with one singe interface (i.e., the view) to see all data related to an experiment, batch, or dataset. The knowledge platform also allows users to find other similar datasets, documents, papers, patents, and web pages. The process of finding similarity is illustrated in other drawings of this application.

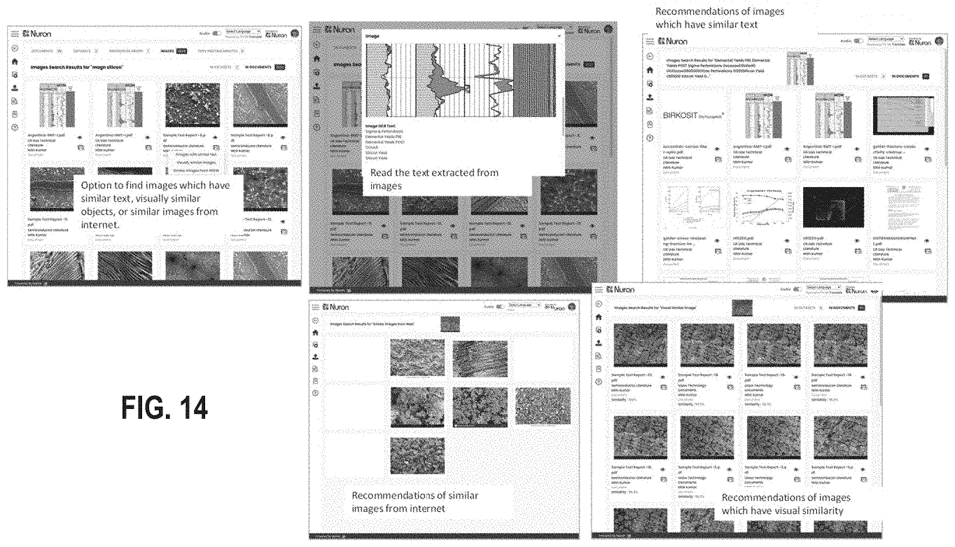

FIG. 14 shows image and image similarity search results. FIG. 14 shows the image search results from an organization's data of internal and external sources. These images could have been extracted from documents and files. FIG. 14 also shows the text information extracted from the image. The image similarity feature allows a user to find other images which have similar textual content or have similar visual features from an organizations own knowledge or from external sources, such as information from the Internet.

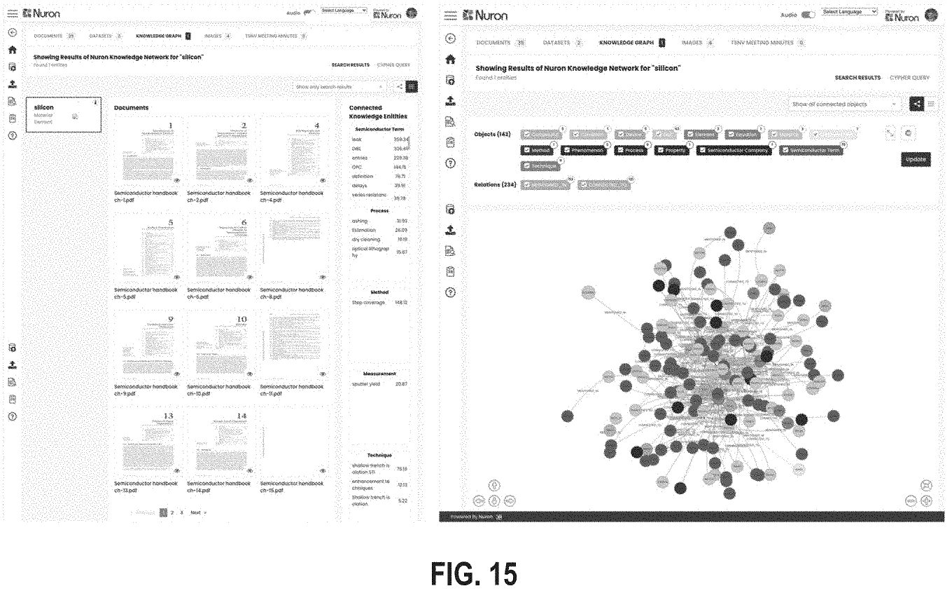

FIG. 15 shows knowledge graph search results. FIG. 15 shows the knowledge graph of a search term (such as one of the search terms mentioned herein). The knowledge graph connects various knowledge entities, concepts, and data together using a process illustrated in other drawings of this application. The process of knowledge graph creation is also illustrated in other drawings of this application. The knowledge graph of an organization's knowledge content can be considered to be the “scientific brain” of a company or organization, such as the “scientific brain” of a university.

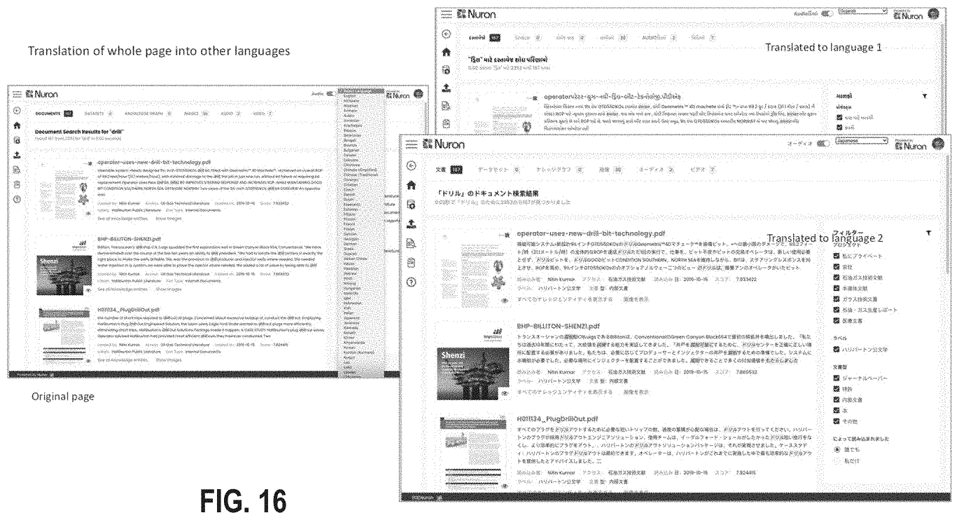

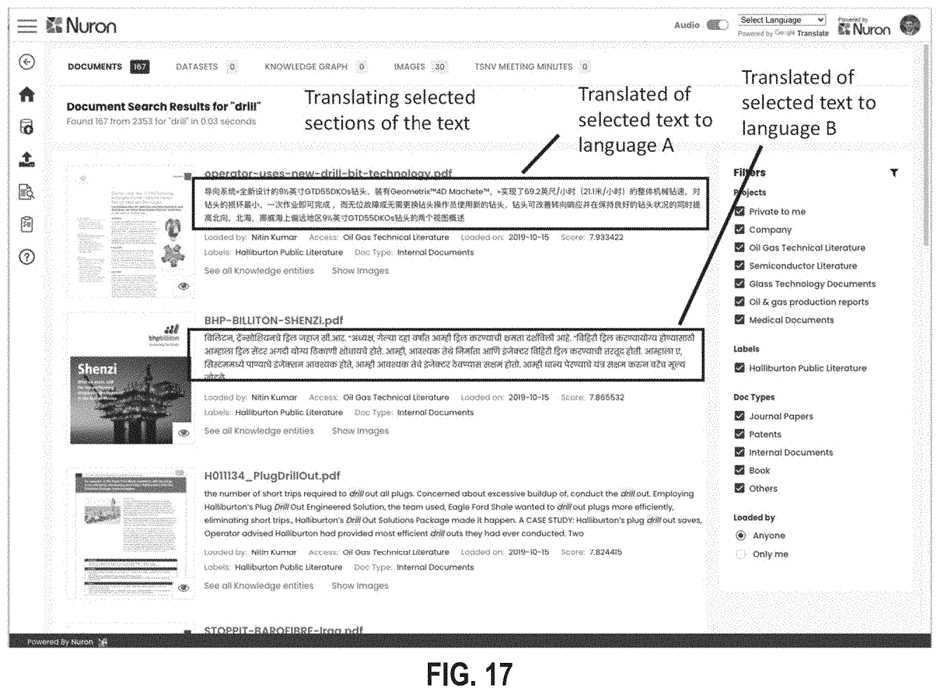

FIG. 16 shows an on-demand translation of a full user screen page. The on-demand translation feature can convert any text content from many languages, such as a language from one of more than fifty languages. The translation features can translate all the text in the user interface or translate only a selected part of the text as shown in FIG. 17.

FIG. 17 shows an on-demand translation of selected text, in accordance with some embodiments of the present disclosure. The translation feature shown in FIG. 17 also allows users to translate only a selected part of the text on any page into many languages, such as more than fifty languages. A user can translate different parts of the page's text into different languages as well.

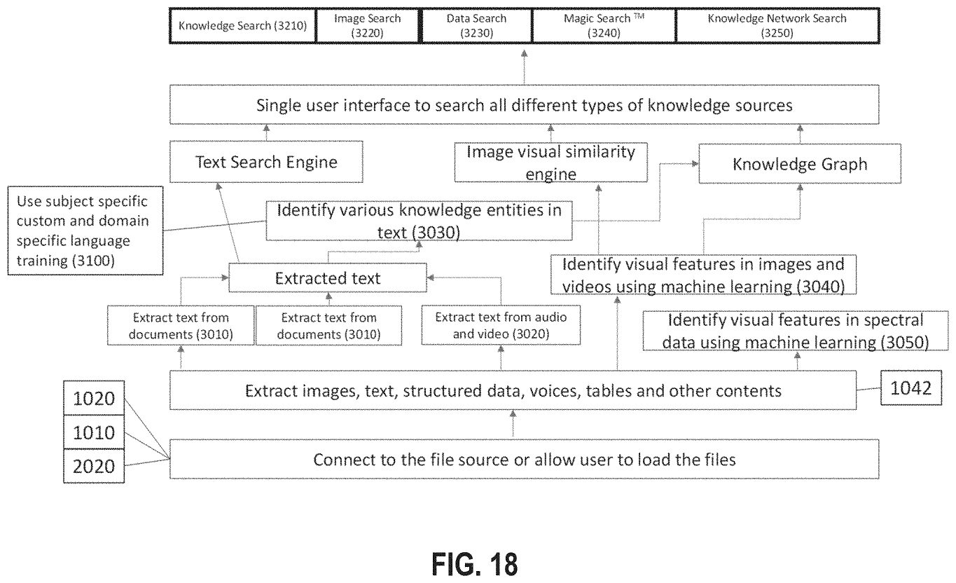

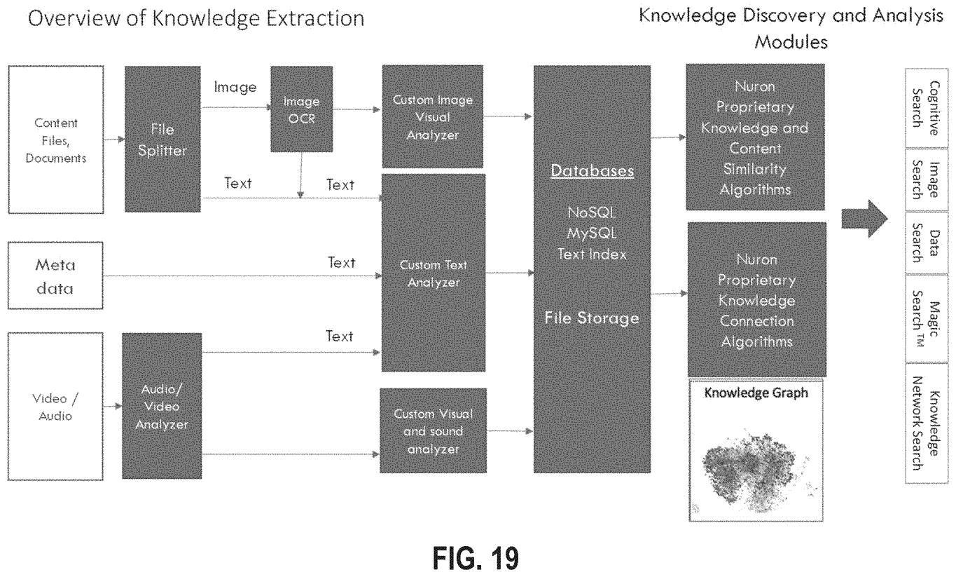

FIGS. 18 and 19 show an overview of the knowledge extraction process, in accordance with some embodiments of the present disclosure. FIGS. 18 and 19 show a flow diagram of processing and extracting knowledge concepts from various files. The two figures show simpler and more detailed versions of the knowledge extraction. The knowledge extraction process involves multiple steps. For example, an initial step (i) of extracting images, text, and meta data from documents. Step (ii), extracting text from images using optical character recognition and text location, and step (iii) identify knowledge entities from the text and meta data. The custom natural language processing engine uses custom training of domain or company specific nomenclature and ontologies. Video and audio files are processed to extract closed captions and text using various speech to text approaches. Video and image analyzers are used to identify various objects as illustrated in other drawings of this application. The knowledge entities and text extracted from documents are saved in various databases to enable searching by text and/or knowledge entities. Also, in some embodiments, many specialized algorithms to identify similarities among various knowledge contents and concepts are used (such as computing systems including artificial neural networks (ANN) and other types of trainable computing systems). Input data and output data of such processes is stored in various databases and used in the knowledge search features shown in the drawings and described herein.

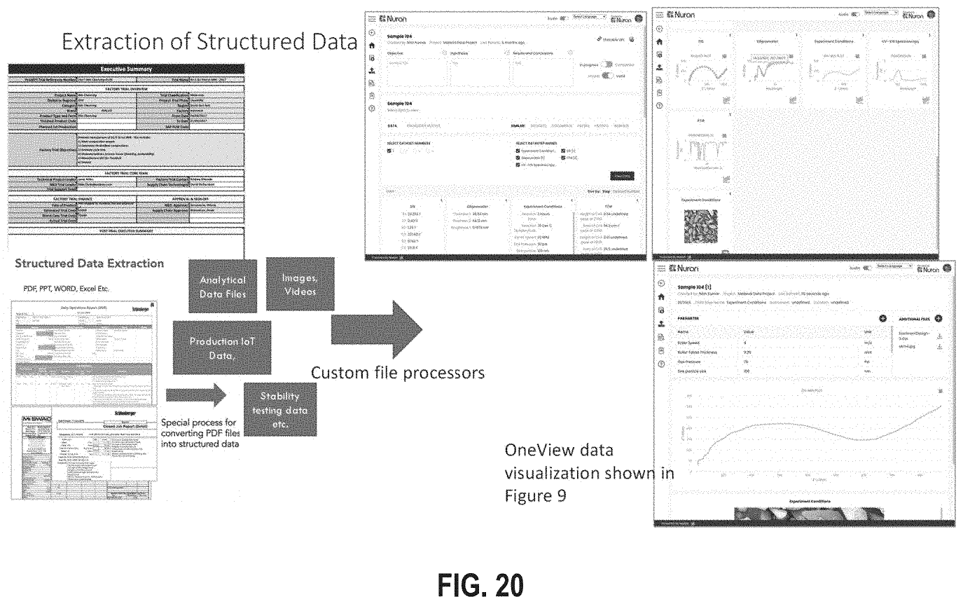

FIG. 20 shows extraction of structured data from various types of files, including documents, IoT files, databases, etc., in accordance with some embodiments of the present disclosure. FIG. 20 shows the process of extraction of structured data as key value pairs, tables, and plots from various types of files. For each type of file, special data loaders are created based on the structure of each file and the data to be extracted. This structured data recombines according to specified experiment or data names/numbers and are saved in the various databases. The data, images, plots, tables of any dataset can be viewed in one interface, as shown in FIG. 13.

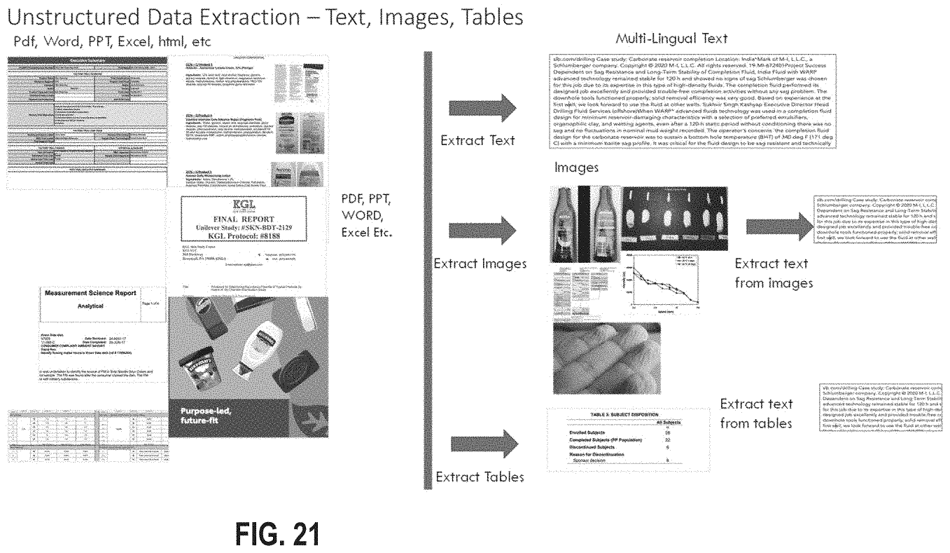

FIG. 21 shows extraction of text from documents, images and texts. FIG. 21 shows the extraction of text, images and tables from various documents. Furthermore, text is extracted from images and tables.

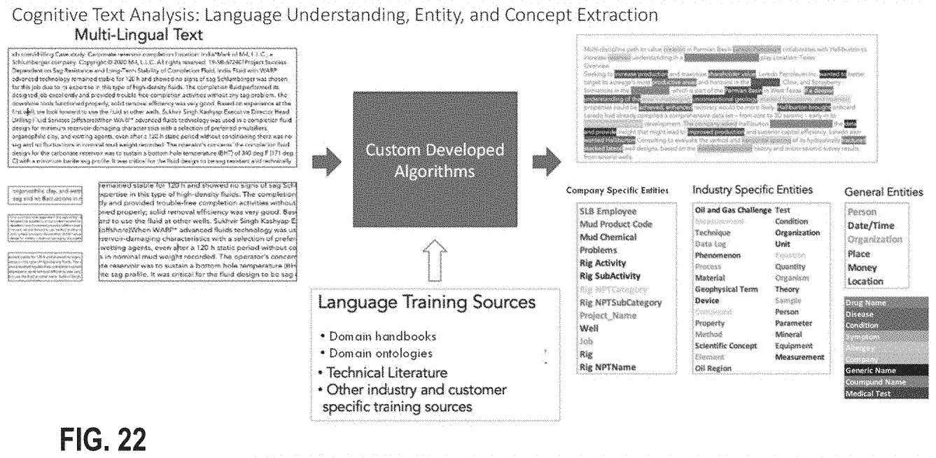

FIG. 22 shows extraction of concepts and knowledge entities from text using computer-implemented language processing and language understanding, in accordance with some embodiments of the present disclosure. The cognitive language processing algorithms described herein are specially trained using domain specific, industry specific, and company specific literature, vocabulary and ontologies. The algorithms can include or be a part of computing systems including artificial neural networks (ANN) and other types of trainable computing systems.

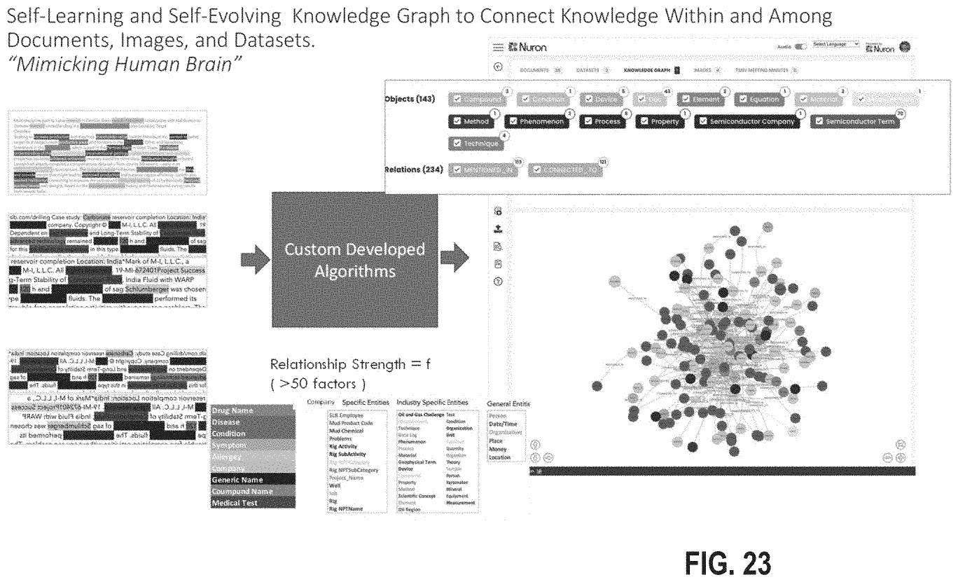

FIG. 23 shows a process of creation of a knowledge graph, in accordance with some embodiments of the present disclosure. Knowledge entities and knowledge concepts are extracted from text extracted from various documents, images, video, and audio. In addition to the entities, their location, their relationship with other words, and sentiments in the text are also extracted. Such information is used to create new relationships among knowledge entities and knowledge contents. Self-evolving relationships are created with more data and documents by taking into account factors (such as more than fifty factors) and a custom developed algorithm. Examples of these factors include number and frequency of the knowledge entities in each document and within the document corpus.

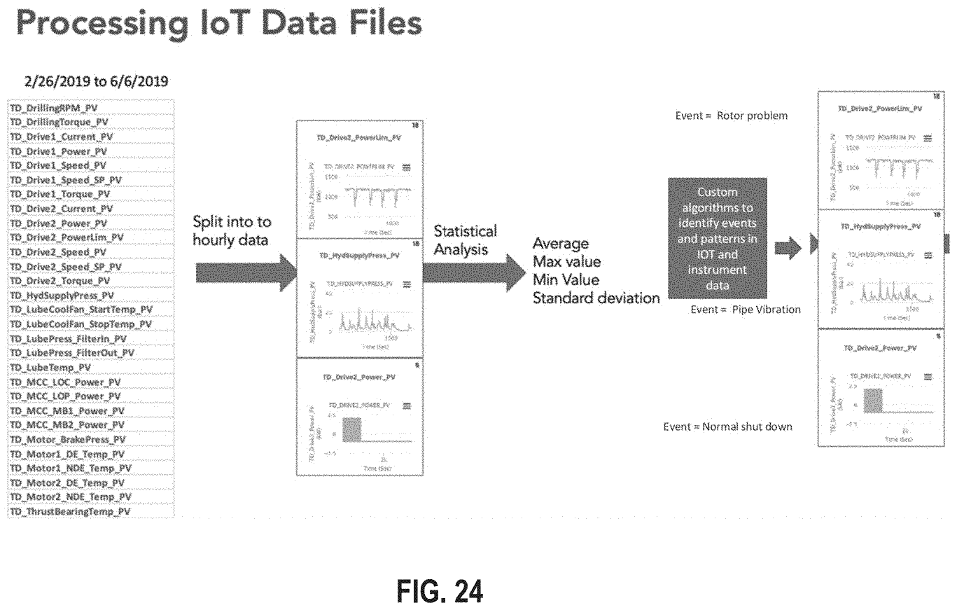

FIG. 24 shows processing of Internet of Thing (IOT) components and instrument data files as well as identification of events and abnormal measurements. In some embodiments, IOT data files are processed, separated and converted into interactive graphs. Various statistical calculations are done from the IOT data as well. Furthermore, custom event and pattern recognition algorithms are used to identify patterns and events in the IOT and instrument data. User can a one click data search in on data repositories of any linked and authorized IOT device and instrument data using statistical values and event and pattern labels.

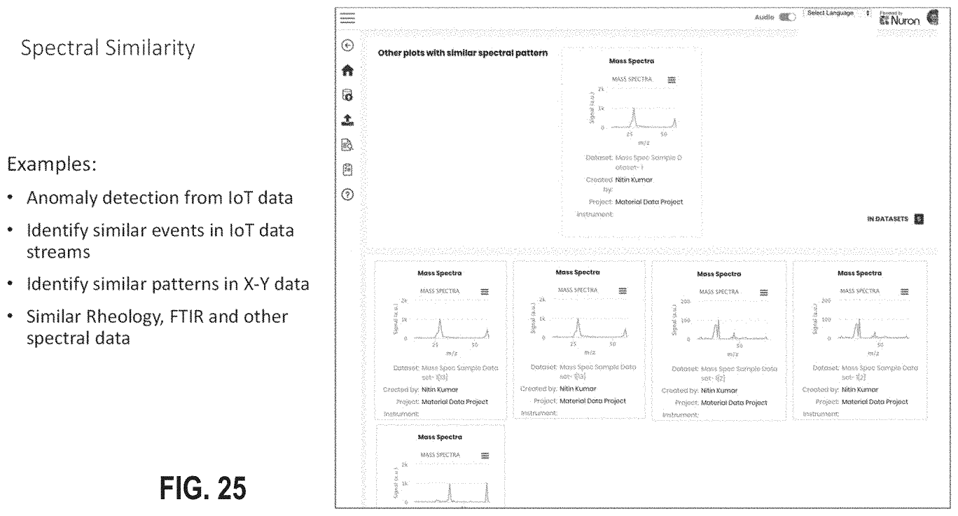

FIG. 25 shows spectral similarity, in accordance with some embodiments of the present disclosure. Spectral similarity feature identifies similar looking spectral and X-Y data, such as from lab instrumentation output. This feature is used to find similar molecular structures, similar events, and other similar patterns, such as in X-Y data (e.g., X-Y graph data). Examples of instrument data type include Fourier transform infrared (FTIR) spectroscopy spectra or data, mass spectra or data, temperature profile, pressure profile, etc.

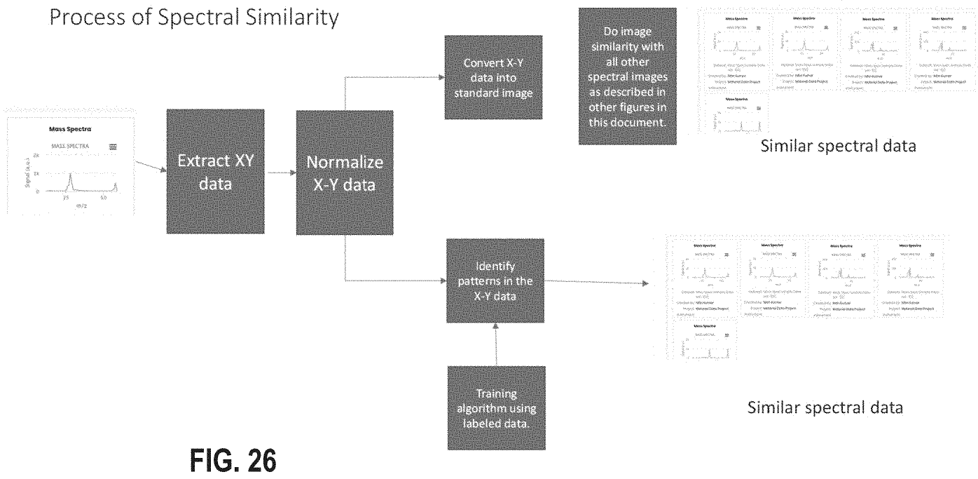

FIG. 26 shows a process of calculating spectral similarity. The process of calculating spectral similarity shown in FIG. 26 includes step (i) extracting X-Y data from the plot, step (ii) normalizing the X-Y data, and step (iii) converting the X-Y plot into a standard image. Also, the process includes step (iv) using the image similarity features as shown in other figures to find other similar spectral. In another approach, the normalized X-Y data is processed by machine learning algorithm which has been pretrained with pre-labeled X-Y data. Both of these methods of spectral similarity can be used and customized in different embodiments of this disclosure.

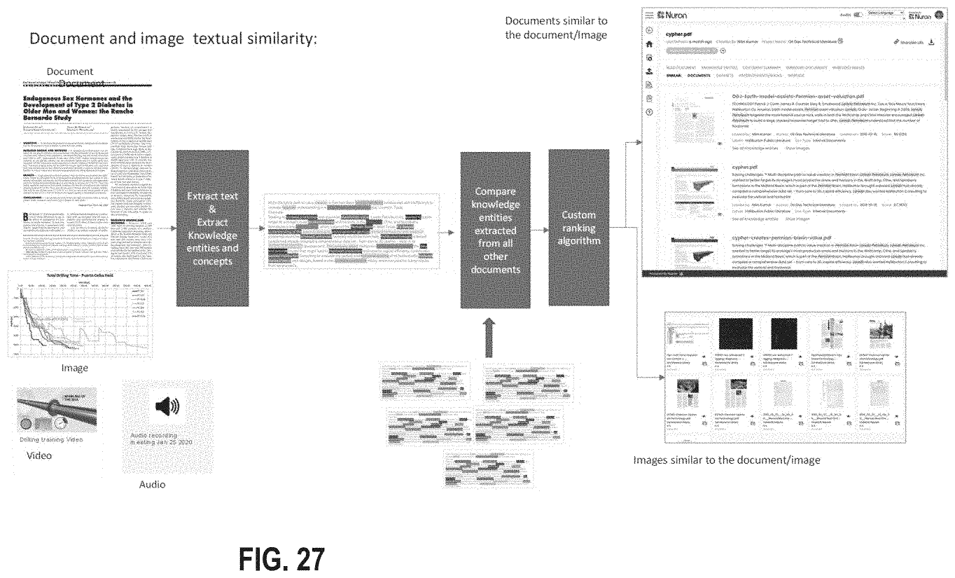

FIG. 27 shows documents and images' textual similarity, in accordance with some embodiments of the present disclosure. The document and image similarity feature, whose results are shown in FIG. 12, works as follows. For example, initially, the knowledge entities and concepts are extracted from documents, such as according to the process described with respect to FIGS. 21 to 23. Next, the entities extracted from the documents are compared with the entities of other documents. Other factors that are used in calculation of similarity include (i) connections and connections strengths among documents, other knowledge entities, and knowledge concepts, (ii) same project, (iii) similar users who loaded the documents, and (iv) similarity of images embedded in the documents, images, etc.

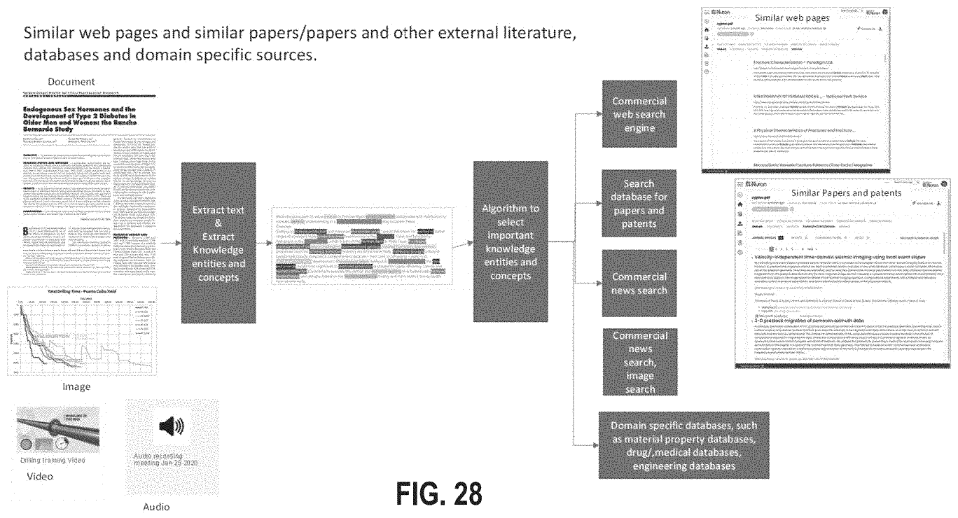

FIG. 28 shows web pages, papers and patents, as well as domain specific contents, in accordance with some embodiments of the present disclosure. Also, FIG. 28 shows a procedure of finding similar documents, images, papers, patents, web pages, web images, news, and other domain specific external knowledge contents, in accordance with some embodiments of the present disclosure. In some embodiments, for any document, or image, or video or audio, knowledge entities are extracted, and based on specific custom algorithms, similar contents from various sources is obtained.

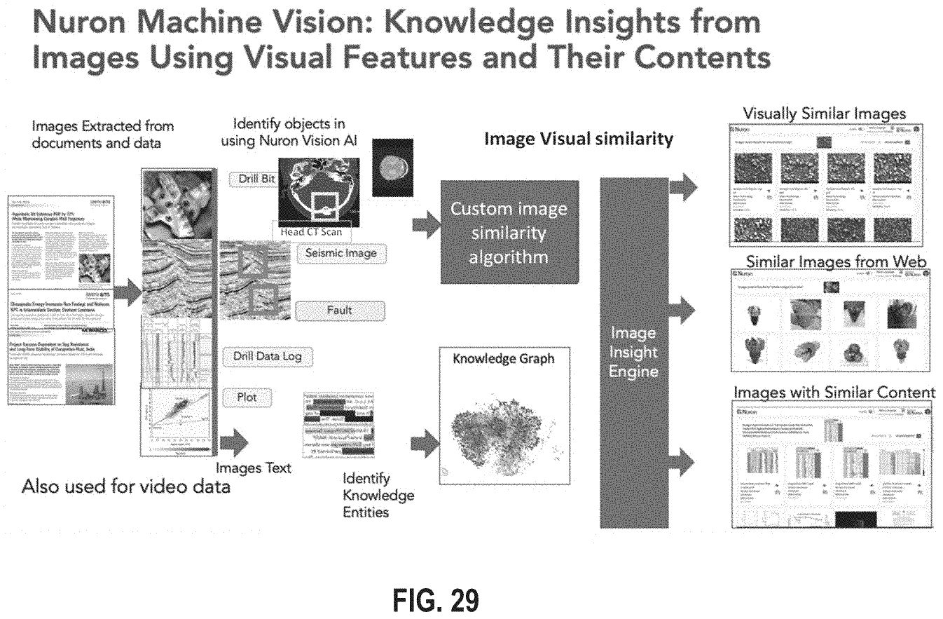

FIG. 29 shows an image visual similarity process, in accordance with some embodiments of the present disclosure. FIG. 29 shows the procedure of finding visually similar images and videos including an initial step wherein (i) images are extracted from documents, and then (ii) videos are processed to find unique images, (iii) custom image classification algorithms are executed to classify images and find visual objects in the images, and (iv) image feature vectors are calculated using various custom developed neural network algorithms. And, in a subsequent step, the process includes (v) comparison of one or more image(s)′ feature vector similarity coefficient with other images feature vectors which have been filtered based on image classification and labels and/or addition of feature vector similarity in the knowledge graph. Then, (vi) using custom image similarity algorithms, visually similar images, and video contents are obtained.

FIG. 30 shows multiple ways to enter search terms for a one click search into an organization's internal knowledge, external knowledge, and user private data. FIG. 30 also shows multiple ways of entering search terms, in accordance with some embodiments of the present disclosure. A user can enter the search text manually. Also, a user can load an image. The image is processed to extract text. The text is filtered to remove unwanted characters. Then it is sent to the one click search to search into the organization's internal knowledge content and eternal knowledge content, such as shown in FIGS. 8 to 10.

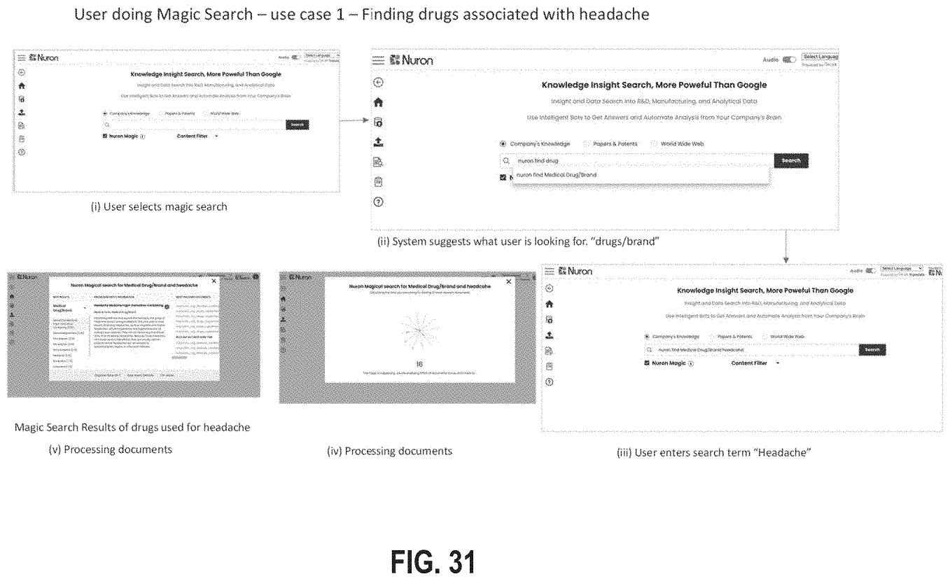

FIG. 31 shows a process of a magic search, in accordance with some embodiments of the present disclosure. In general, the magic search feature machine reads the documents of search results and finds the specific concept of a knowledge entity that a user is looking for. The main problem with many current search approaches is that they provide a user with knowledge content such as a document or a web page or an image. The reader then has to manually read the document, web page, text of image, hear audio, or watch video to get what they are looking for. For example, if from a medical document, a user wants to see which drugs are associated with a symptom, they search for the symptom key words, and then they will have to read one or more documents to know what drugs are associated with particular symptoms. It may take them a few minutes to hours to read the documents, web pages etc. The magic search feature machine reads the documents of search results and finds the specific concept of a knowledge entity that a user is looking for. For example, if user wants to know what drugs are associated or related to “headache” the steps of the magic search include: step (i) user selects magic search; step (ii) the platform understands user's “intent”, i.e. what user is looking for; step (iii) user is provided field(s) to then enter search terms; step (iv) the platform processes the search documents by machine reading; and step (v) calculates the ranking of knowledge entities and concepts based on their presence in the search documents. Also, the process can include presenting the results to the user in a last step.

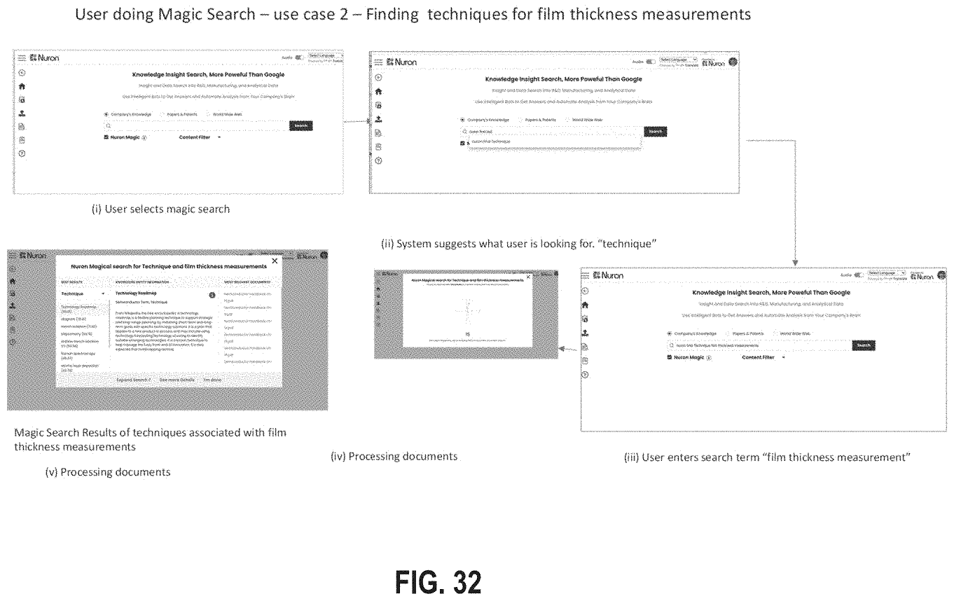

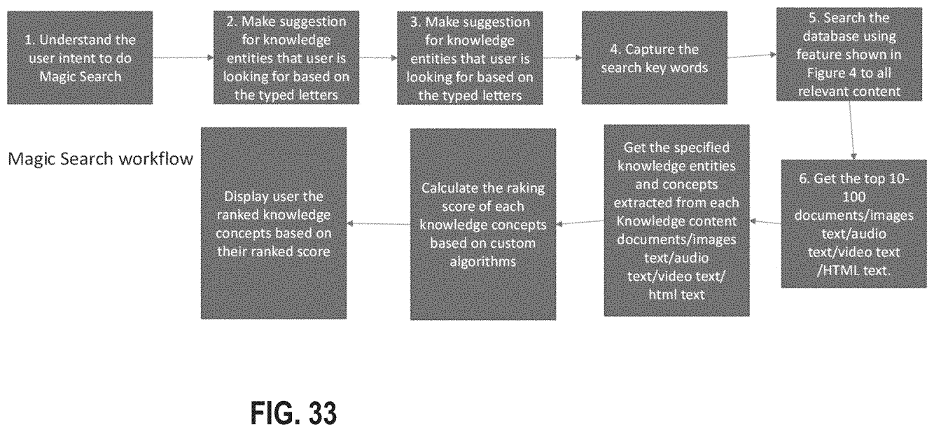

FIG. 32 shows examples of a magic search, in accordance with some embodiments of the present disclosure. FIG. 32 shows a user trying to find “Techniques” used for or associated with “film thickness measurements”. In the same way as shown in FIG. 31, the system finds the associated techniques and presents the user with the results. FIG. 33 shows a flow diagram of an example of the magic search described herein.

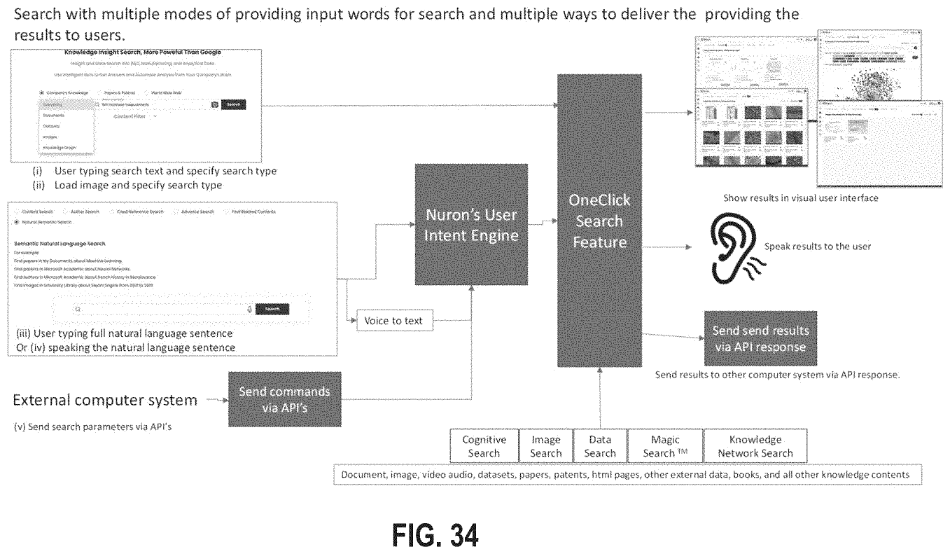

FIG. 34 shows multiple ways for users to provide search information. The process in FIG. 34 includes steps (i) and (ii), manually typing search terms and entering search terms; steps (iii) and (iv), using natural language processing and the intent search engine to understand what search a user wants to do, and search keywords by typing or by speaking into a microphone; and step (v) sending search terms and search selection parameters via API's. Upon receiving the search types, parameters and terms, the system users intent search engine attempts to understand the user's intent. The search petameters are sent to the one click system to generate results from various knowledge contents. The search results can be shown to the user in a visual interface, outputted via a speaker or sent via API response, or a combination thereof.

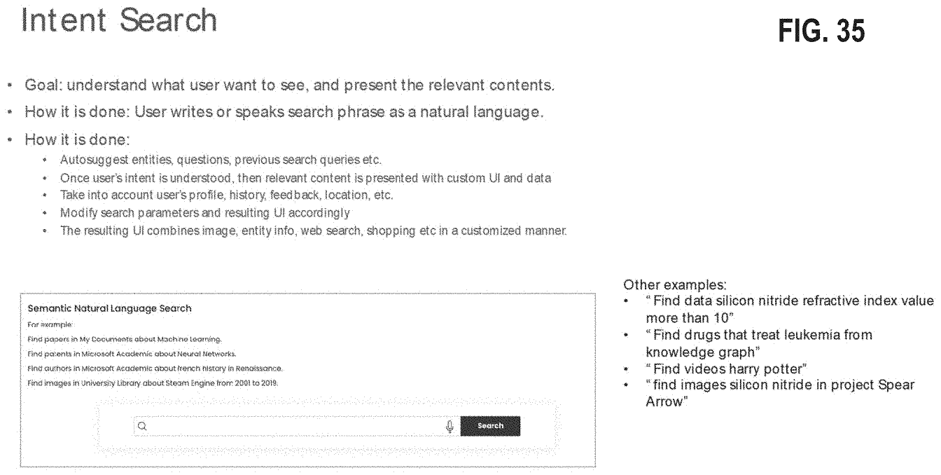

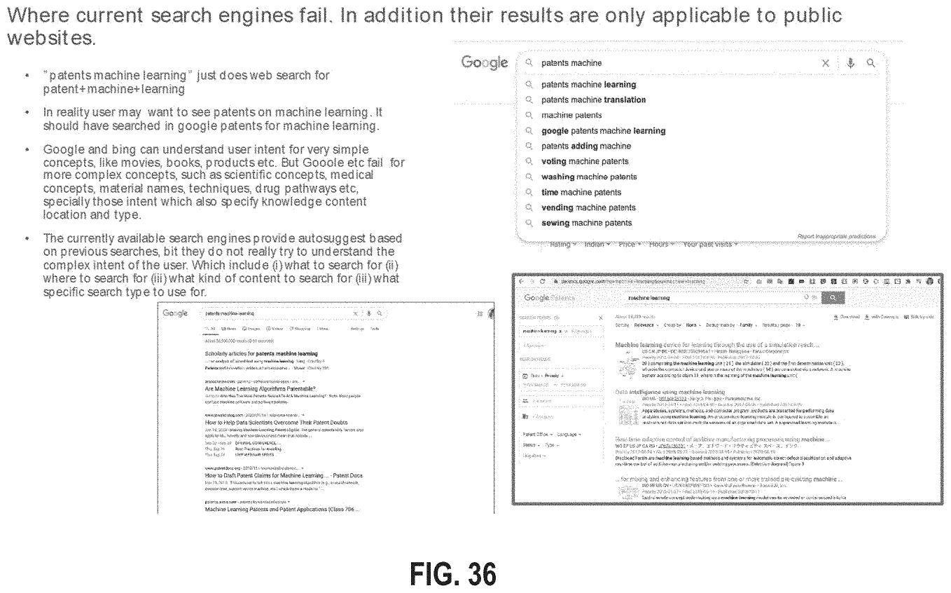

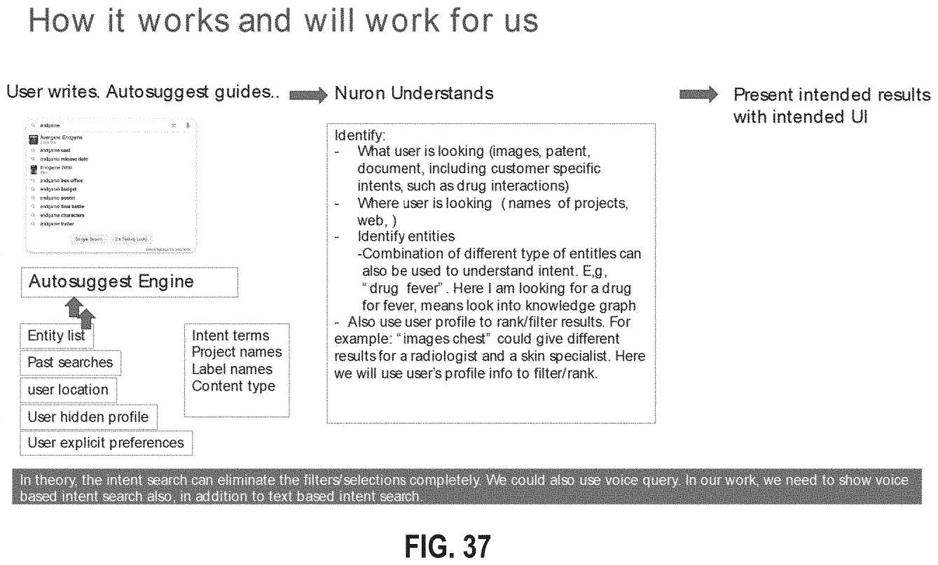

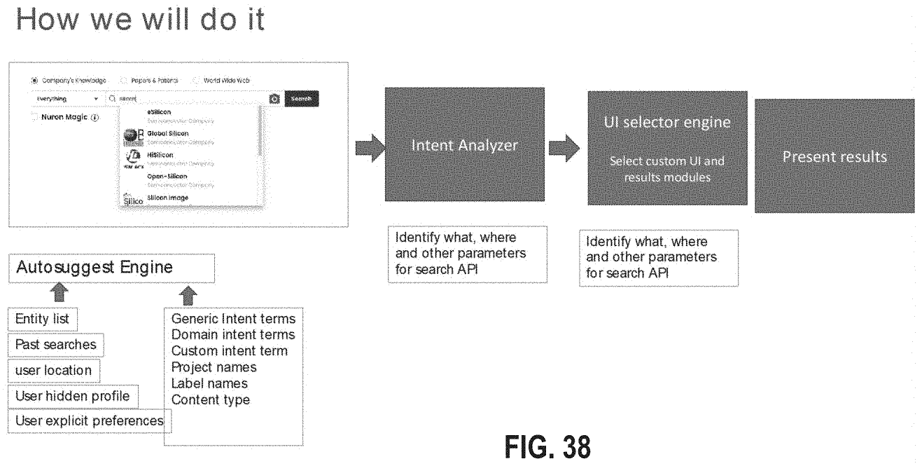

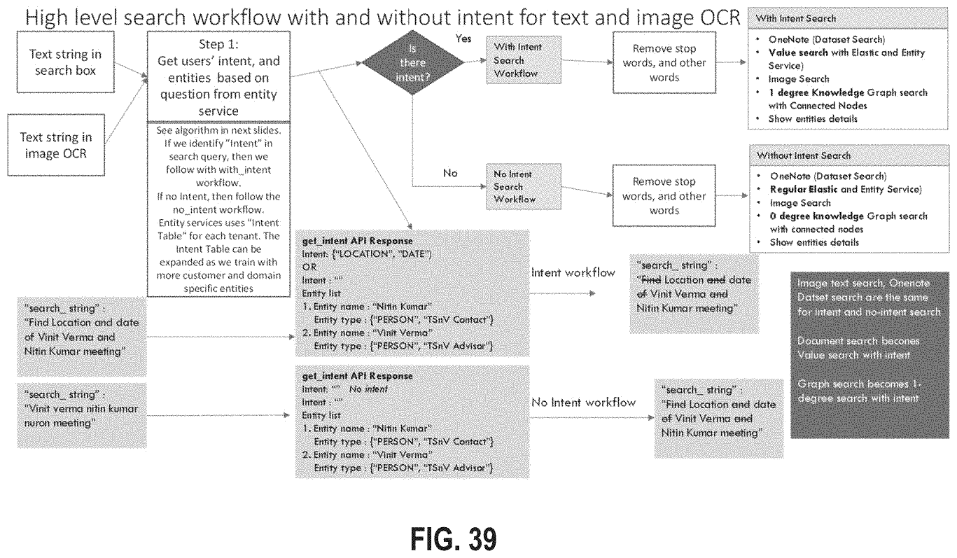

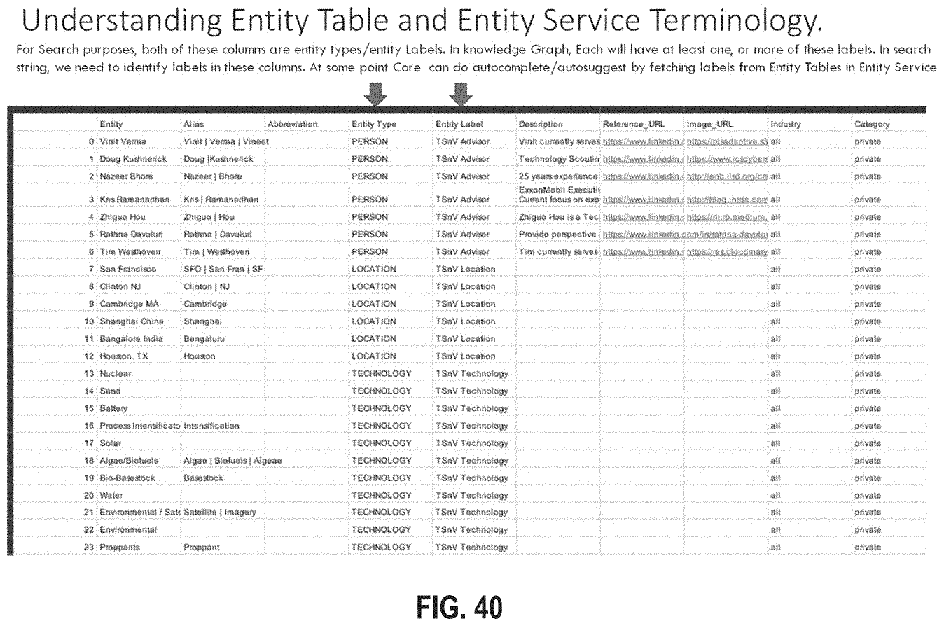

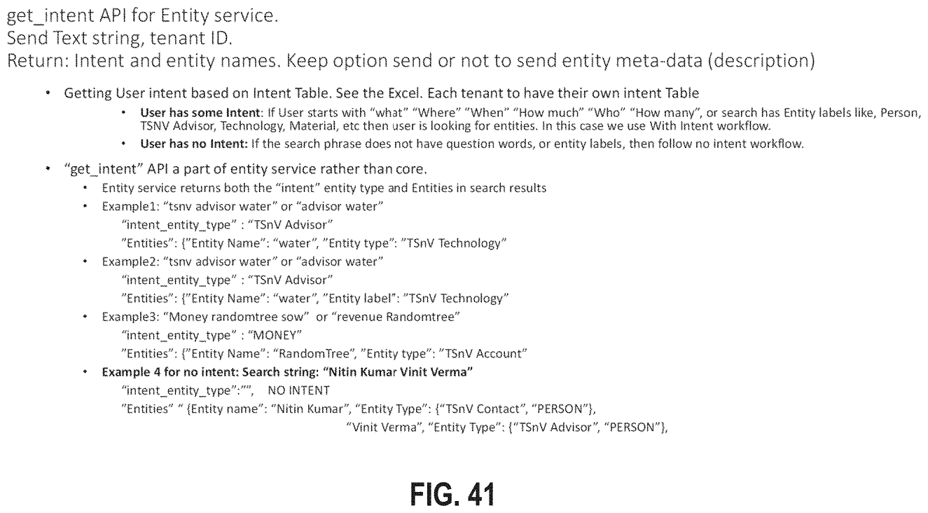

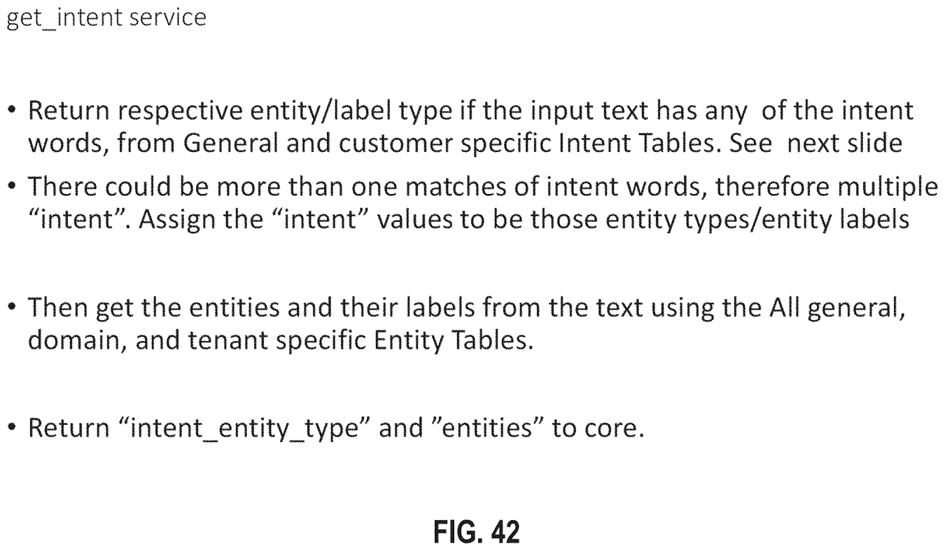

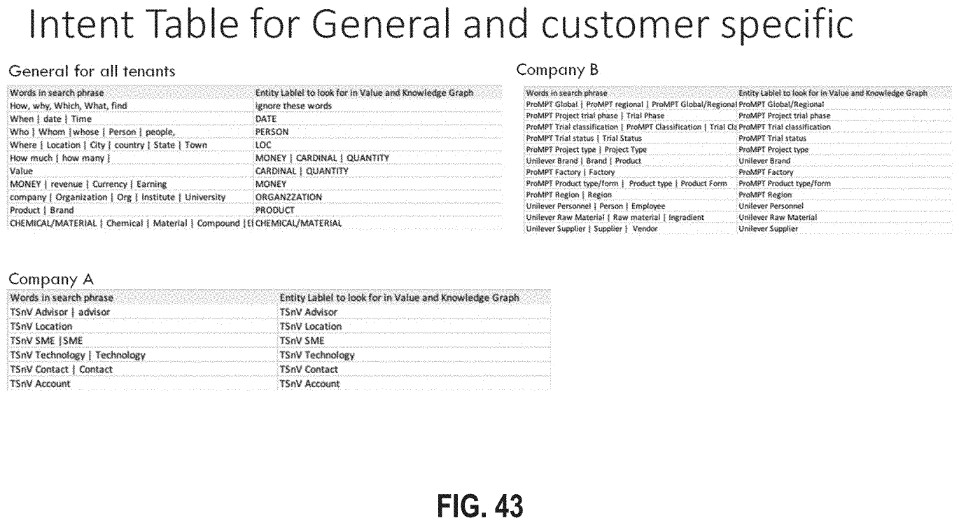

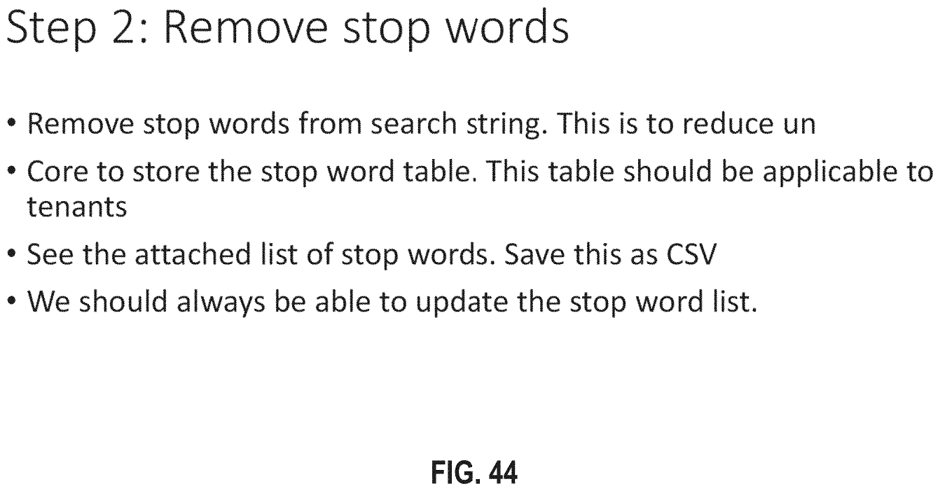

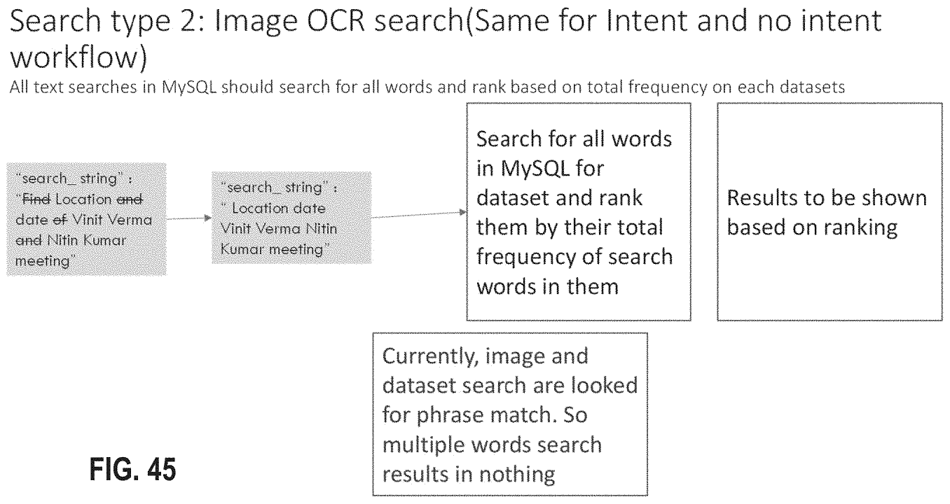

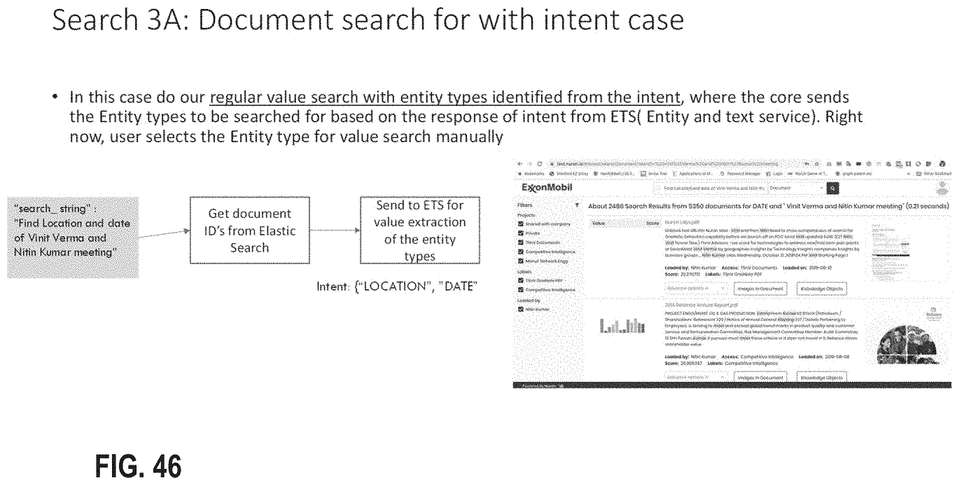

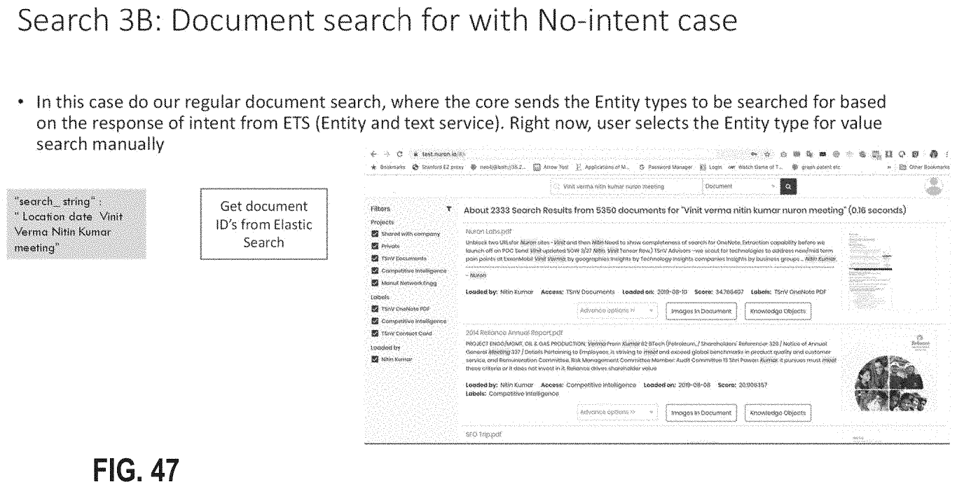

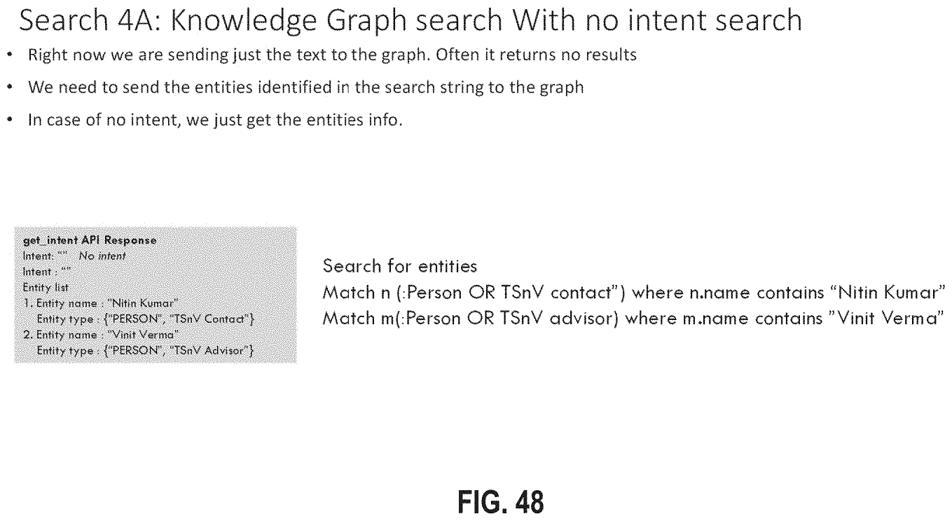

FIGS. 35 to 48 show processes and aspects of understanding the user's intent and procedures and workflows of the user intent engine, in accordance with some embodiments of the present disclosure. These figure describe in detail the process of understanding the user's intent, as well as procedures and workflow of the user intent engine (as shown in FIG. 4) and displaying the results. In some embodiments, intent search is a feature where a user writes or speaks a sentence or a phrase, and the platform tries to interpret what user is searching for, where user is searching for, which search feature user wants to use, and/or how user wants to access the results, via voice or via visual interface.

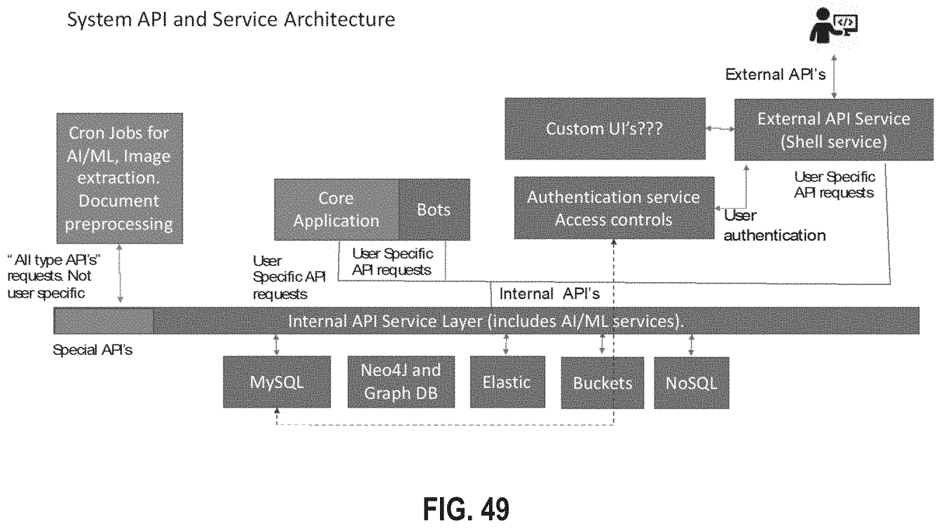

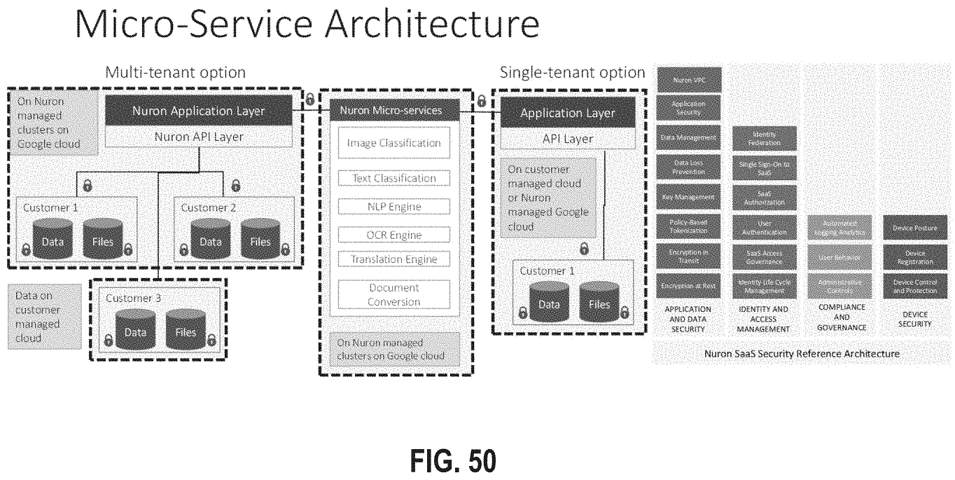

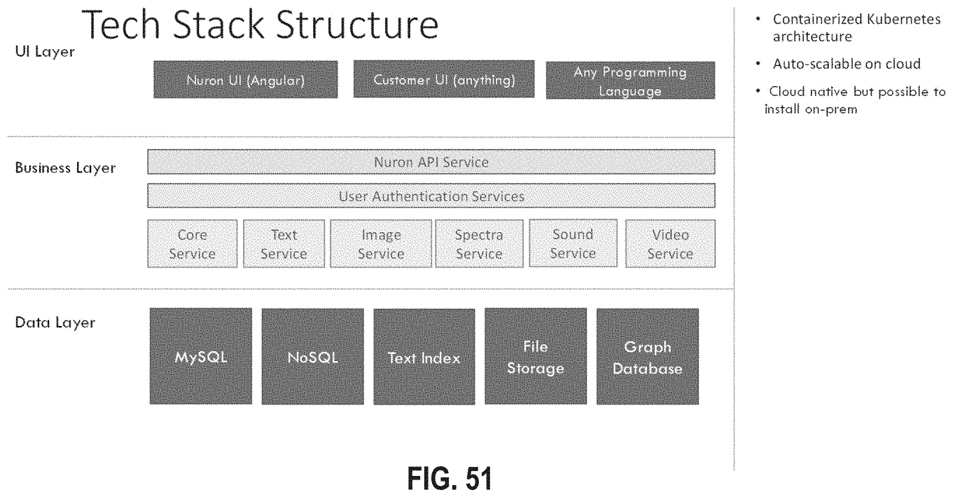

FIGS. 49 to 51 show an overall architecture of a knowledge search and analysis platform, in accordance with some embodiments of the present disclosure. For instance, FIG. 49 shows various microservices and modules that make up the knowledge search and analysis platform.

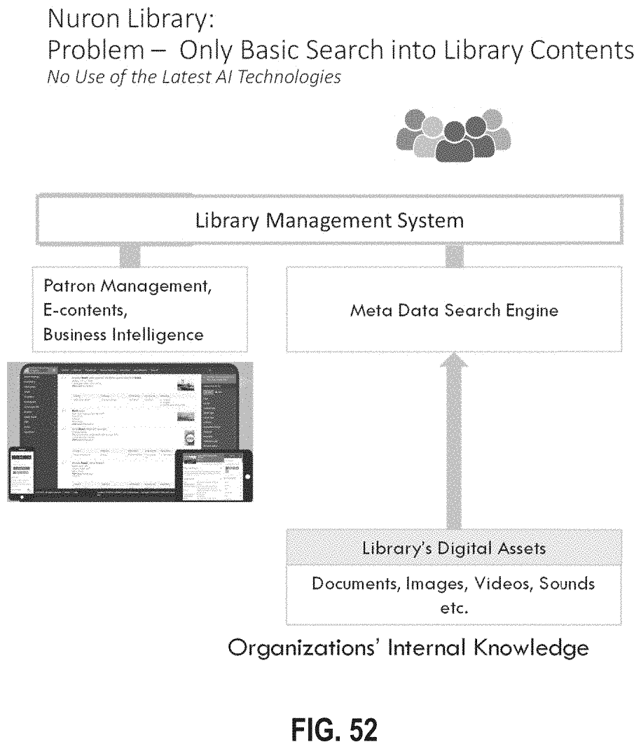

FIGS. 52 to 55 show an implementation of the one click knowledge platform (i.e., single point knowledge platform) and use of its libraries, in accordance with some embodiments of the present disclosure. FIGS. 52 to 55 illustrate an implementation of the one click knowledge platform for the use of libraries as well as its library knowledge search and analysis. The library knowledge search and analysis allow users to search an organization's contents, the library's contents, and also the contents subscribed to by the library. For example: a researcher in a university wants to search in (i) all the reports she/he has written, (ii) all doctoral theses that others in her/his universities have written which are available as university collection, and (iii) all papers, patents, books published.

There are few major problems with other systems in performing such a task, which have been overcome by the system described herein. For example, currently it is not possible to provide one-place cognitive search into an organization's own content, library/organization's knowledge contents, and all public literature. Second problem is that the search is done only by the meta data in known systems. The library search of such systems do not take into account the contents, knowledge entities, and connections among various knowledge contents. Also, it is often not possible to combine search results of different types of contents. Further, it is often not possible to connect image contents with documents, or videos or sound.

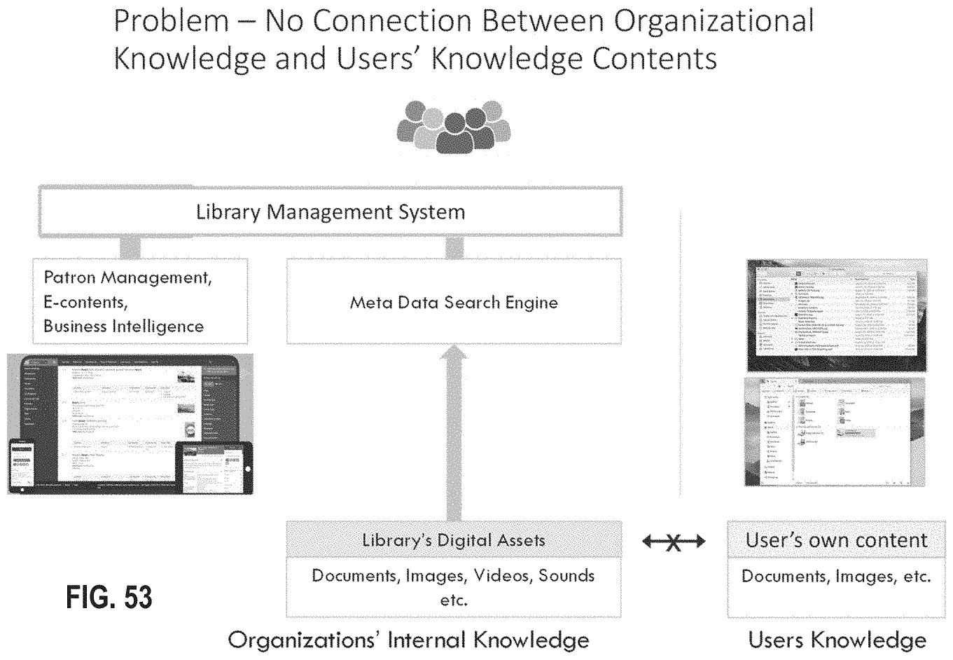

FIG. 52 shows the current library search engines that mostly use contents' meta data. FIG. 53 shows how users' own contents are not connected and not searchable along with library's own content.

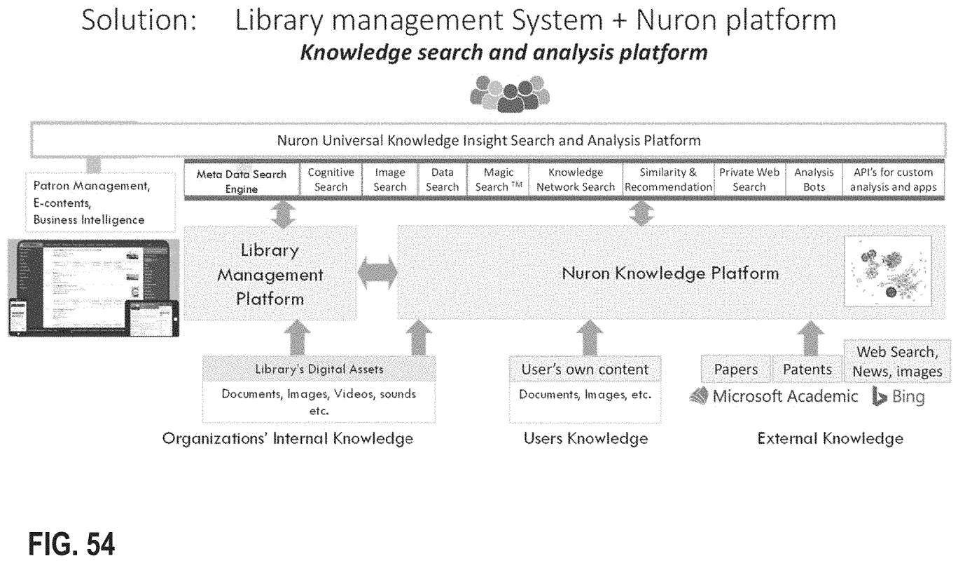

To solve such problems technically, the one click knowledge platform uses at least its libraries. FIG. 54 describes the knowledge search platform for libraries that enables cognitive search and analysis into various types of knowledge contents from library/organization, user, and public literature. The one click knowledge search and analysis platform, as illustrated in FIG. 54 connects to the library management system, libraries' various digital contents in different formats (documents, books, images, videos, audios, etc.), in different collections, users own contents, and external knowledge contents such as papers, patents, and web search. The one click knowledge platform combines such contents, processes the contents, and provides users different kinds of knowledge search and analysis options, such as shown in many drawings of this application.

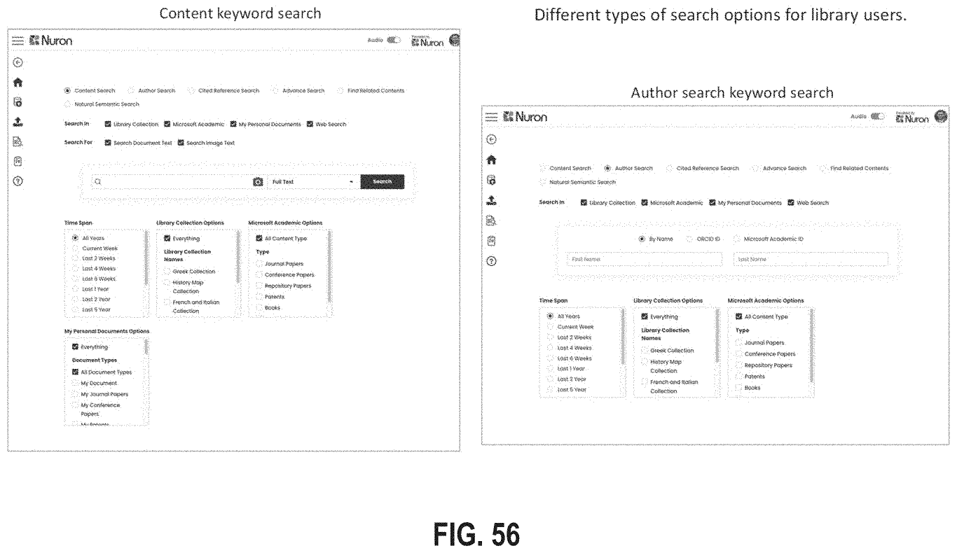

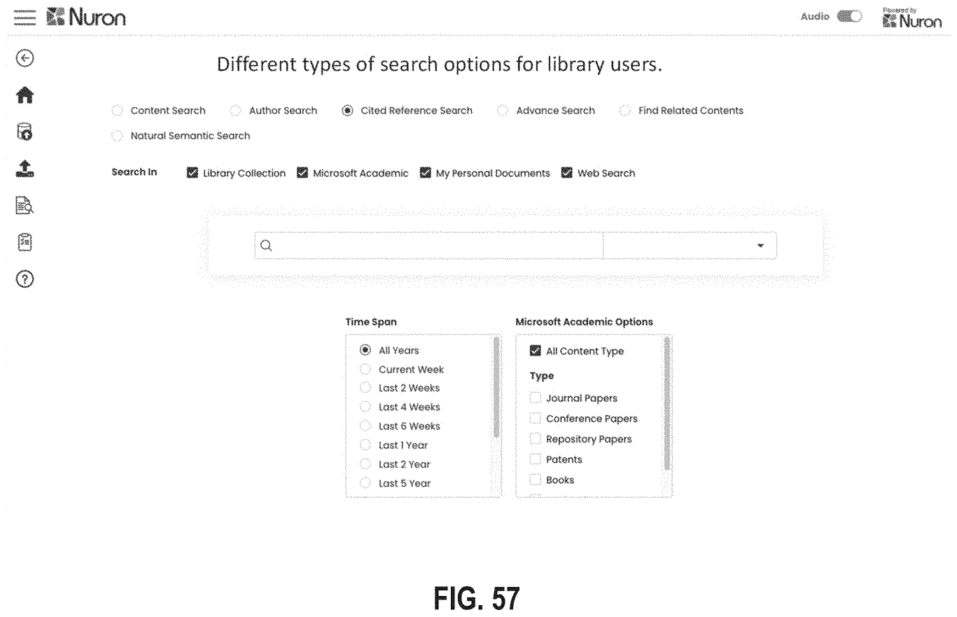

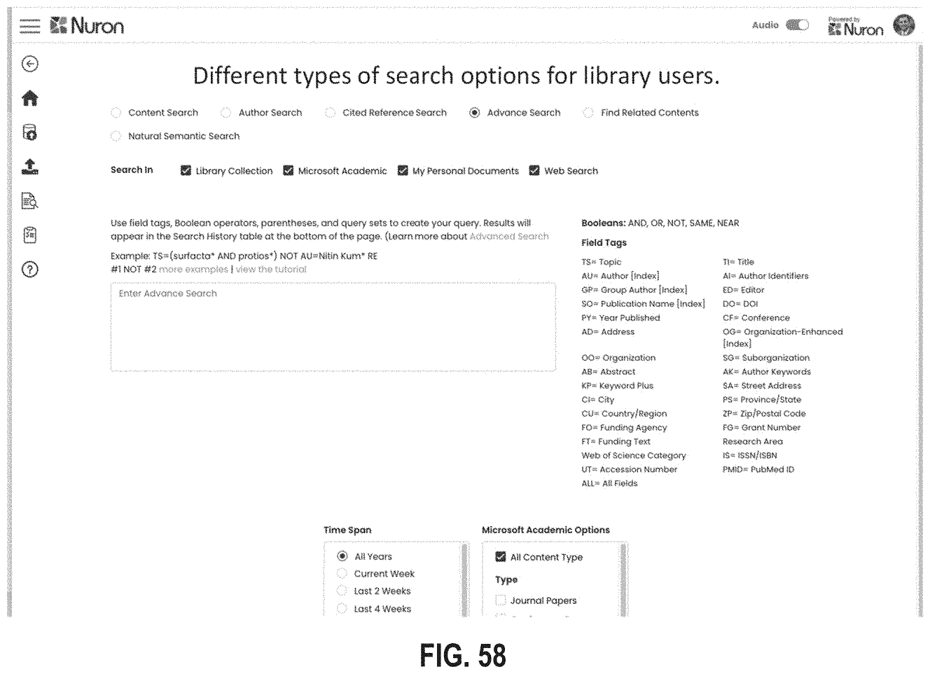

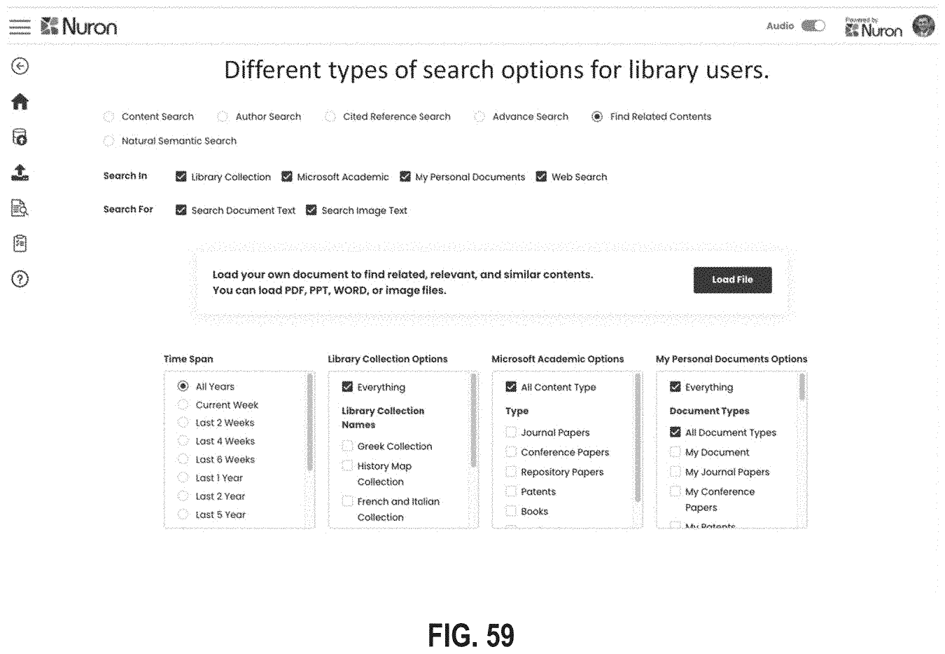

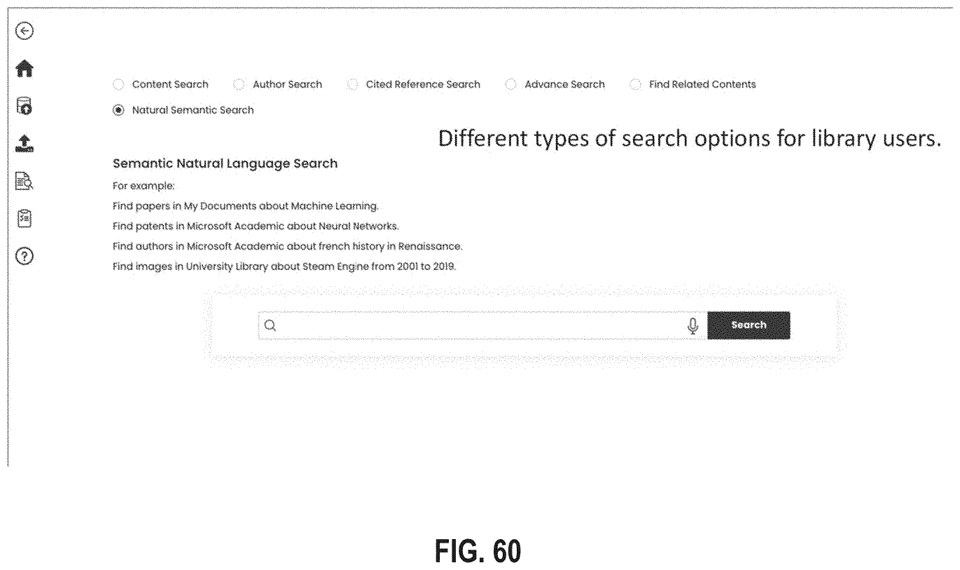

FIGS. 56 to 60 show various types of search options available to library users of the platform, in accordance with some embodiments of the present disclosure. For instance, FIG. 56 shows that users can search into different types of contents in a library, their own documents, public literature, and web by (i) content keyword search and (ii) author search. FIG. 57 shows a cited reference search into public literature, library collection, and users own contents. FIG. 58 shows a user can combine various meta data to search for knowledge contents. FIG. 58 also shows more details of an implementation of the knowledge platform. FIG. 59 shows feature where user can load a document to find similar documents available in library collection, public literature, web, and their own personal documents/knowledge contents. FIG. 60 shows the implementation of intent and semantic search feature.

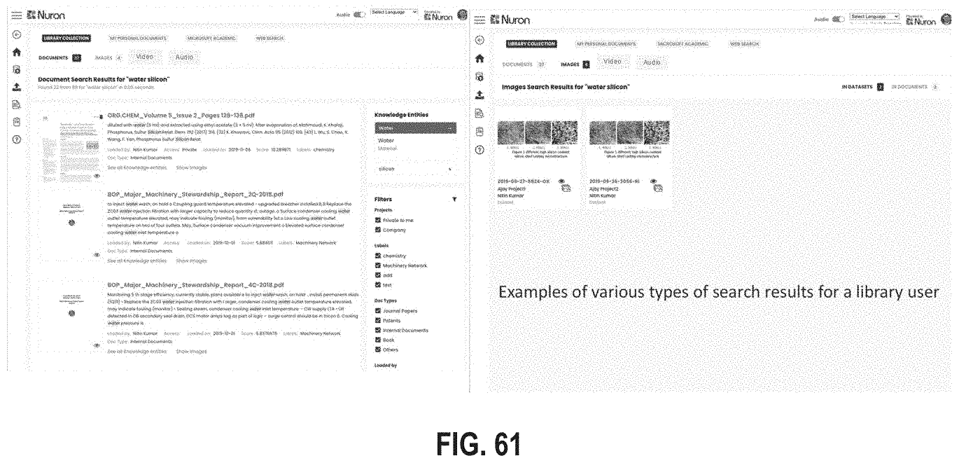

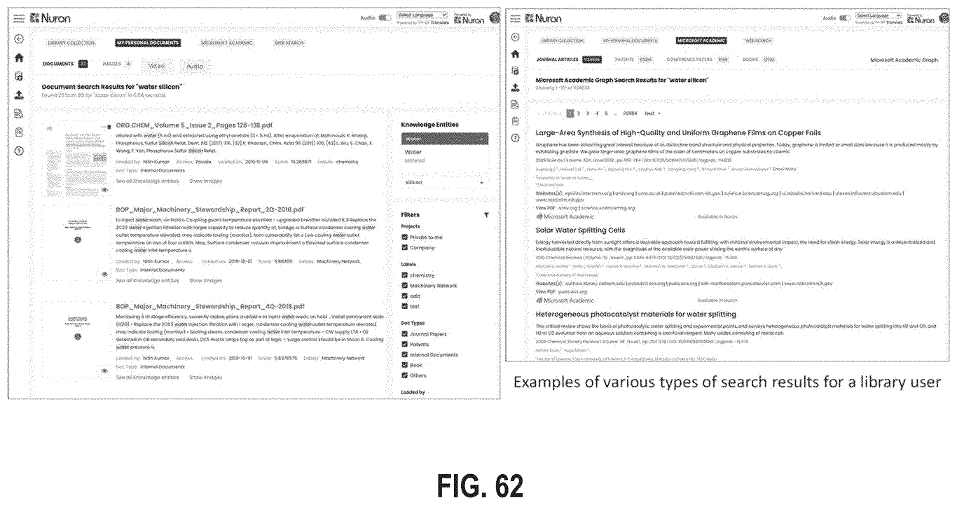

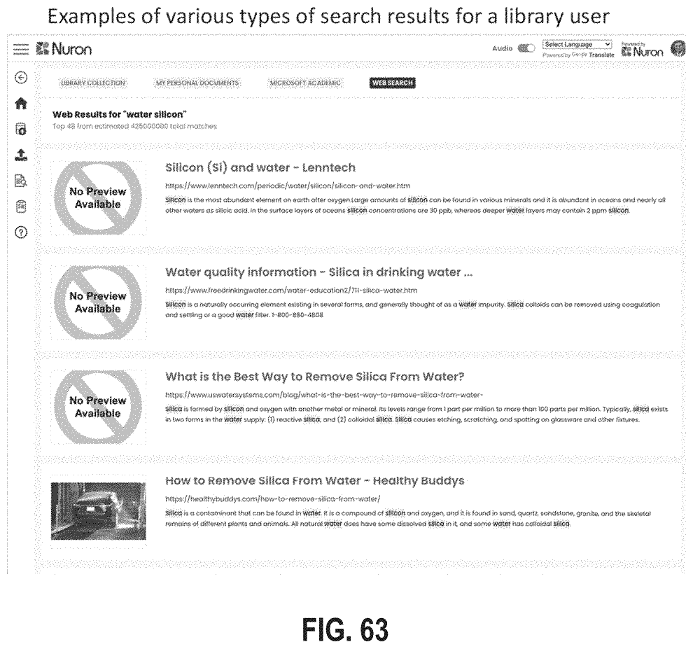

FIGS. 61 to 63 show various search results from a library knowledge search and analysis engine, in accordance with some embodiments of the present disclosure. With one click, on a single interface, a user can see results for a knowledge search, which includes documents, images, papers, patents, video, sounds etc. from various collections of library, their own contents, public contents, and web search results.

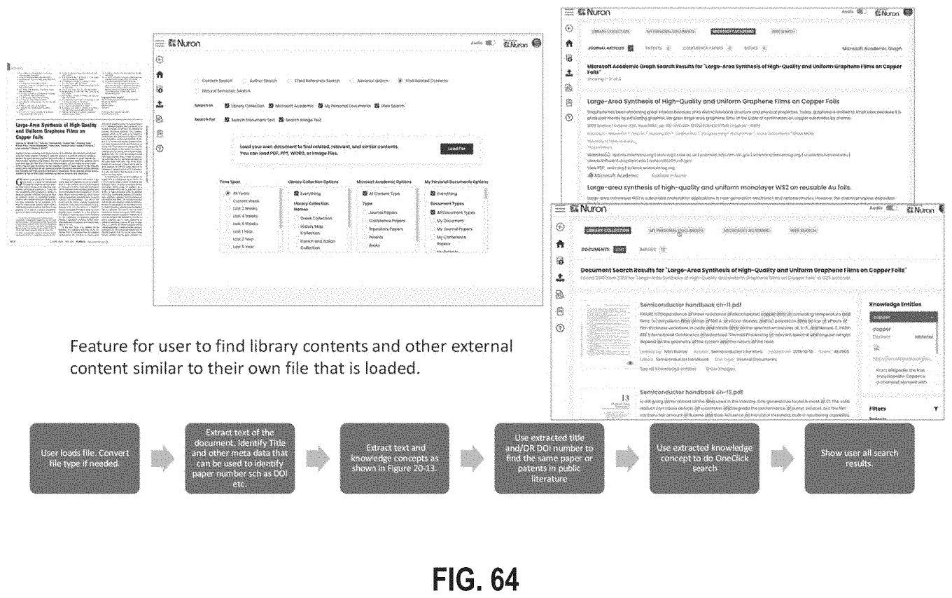

FIG. 64 shows a feature that allows users to load their own document, in accordance with some embodiments of the present disclosure. This feature allows user to load their own document and the knowledge search platform finds same or similar related knowledge contents from external and internal sources. The corresponding procedure is also shown in FIG. 64.

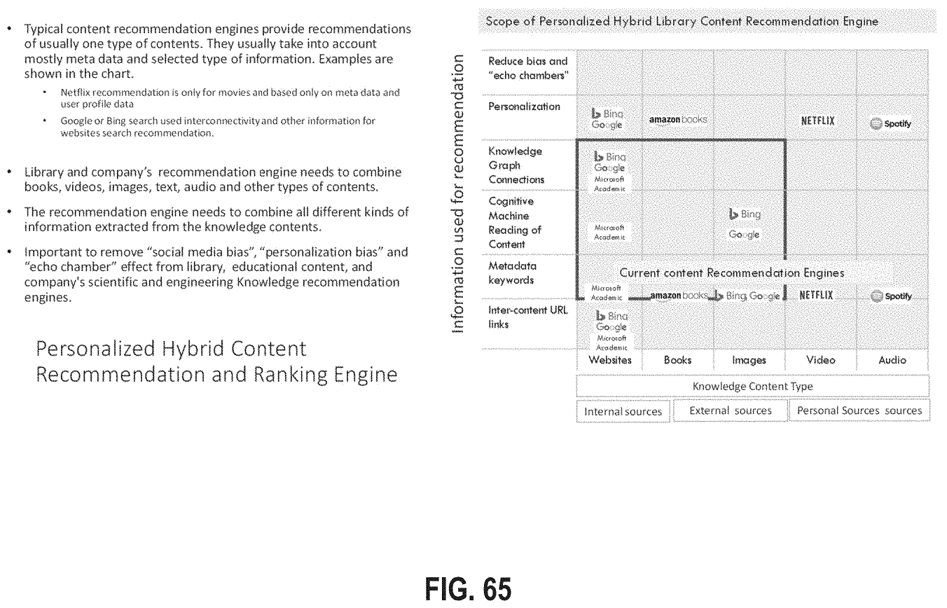

FIG. 65 shows a hybrid content recommendation engine, in accordance with some embodiments of the present disclosure. The current recommendation engines work mostly with one type of content. These current recommendation strategies are not suitable for content recommendation engines for scientific and engineering knowledge, a variety of library knowledge and other types of domain/industry knowledge contents. As shown in FIG. 65, the system described herein can include a personalize hybrid content recommendation engine that takes into account information, including the documents interconnectivity, its knowledge entities, visual features, machine read contents, user personal information, meta data, etc.

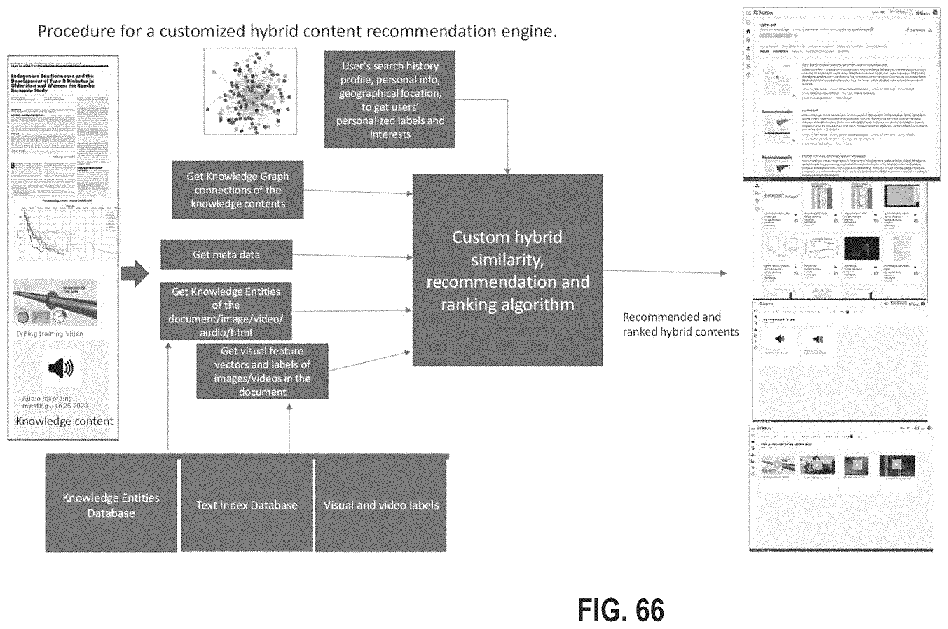

FIG. 66 shows a procedure to use various types of information (e.g., see FIG. 65), in accordance with some embodiments of the present disclosure. The procedure also uses customizable algorithms to get personalized recommendation and ranking of recommended contents. The custom personalized recommendation system combines the meta data, knowledge contents, knowledge graph connections, labels and features from images, videos and audio, and user's preferences, search profile, etc. to recommend specific contents to the user.

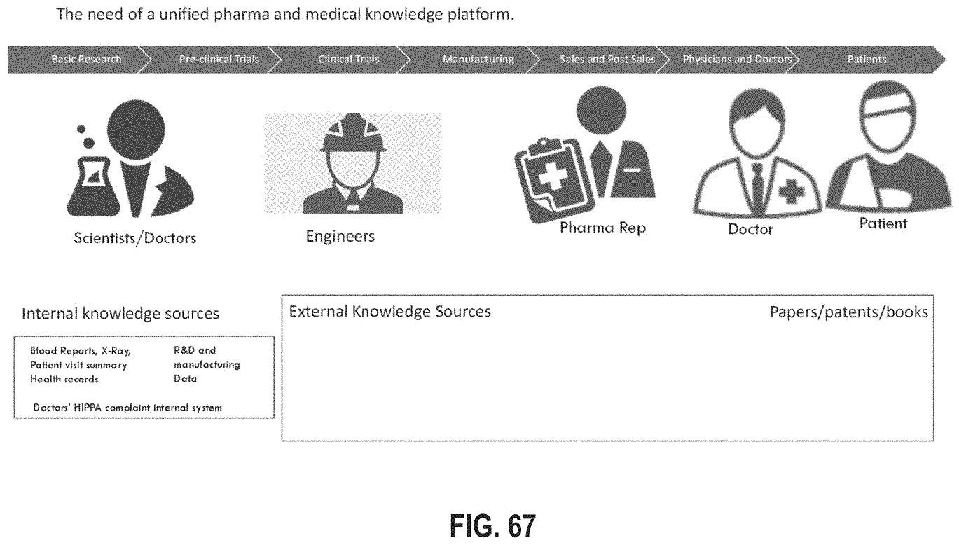

FIG. 67 shows a use case of the one click knowledge search and analysis platform, in accordance with some embodiments of the present disclosure. In the case of FIG. 67, the platform is applied to specific industry of pharmaceutical and medicine. In the pharma and medical industry, people from research scientists, to engineers, pharma salespeople, physicians and finally patients search many external public sources of knowledge separately. Physicians, engineers, researchers also search their own internal knowledge sources, which may include patients reports, data, experiments data production data, etc. There is no cognitive knowledge search and analysis platform designed for all people from researchers to patents to enable single unified cognitive knowledge search and analysis of all external and internal knowledge. The one click knowledge search and analysis platform overcomes such issues.

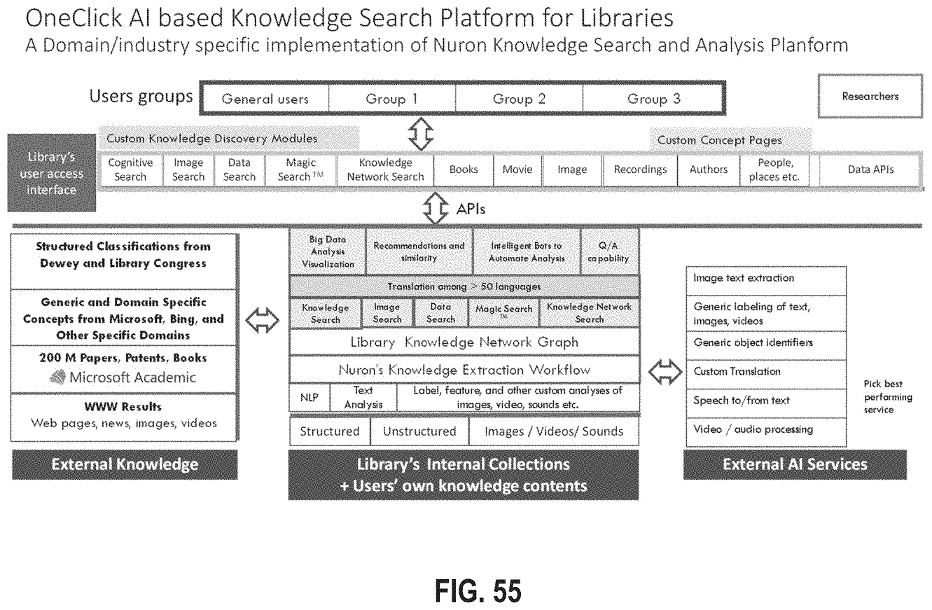

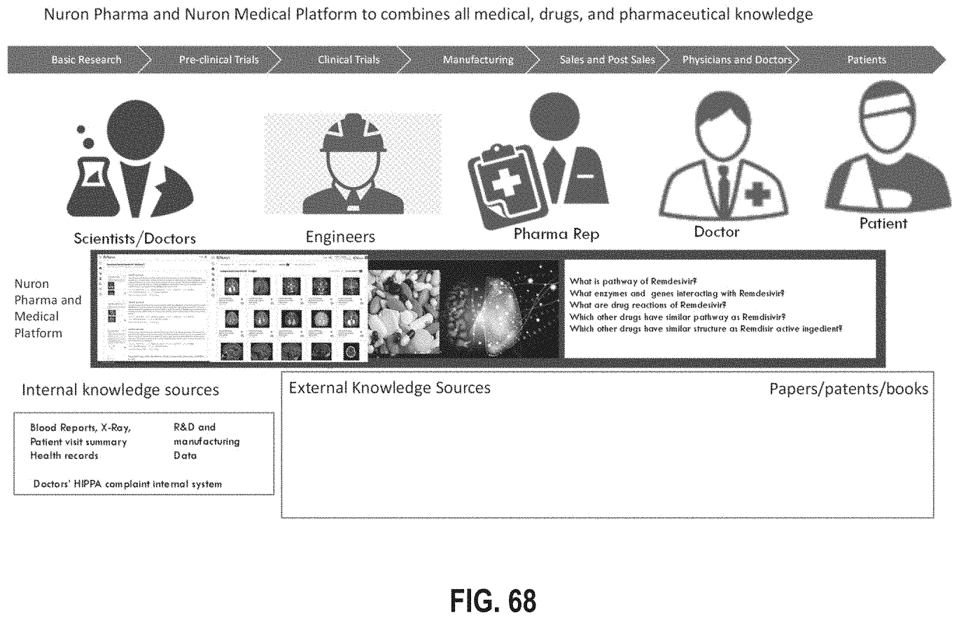

FIG. 68 shows a pharma and medical knowledge analysis platform, in accordance with some embodiments of the present disclosure. The platform brings pharma and medical knowledge and data sources into one single place and combines with an organization's and user's own data and knowledge (e.g., see FIG. 55).

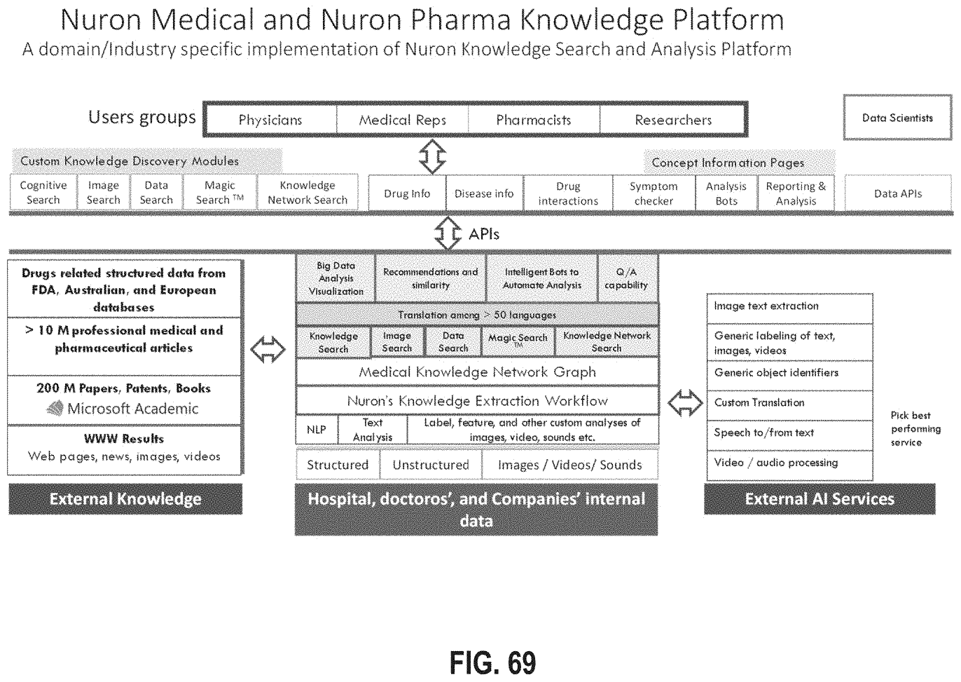

FIG. 69 shows customizations of a core platform (such as the platform shown in FIG. 6), in accordance with some embodiments of the present disclosure. The customizations shown in the drawing are for the pharma and medical industry and domain. The Pharma and medical knowledge search and analysis platform is built on the same core knowledge search and analysis platform.

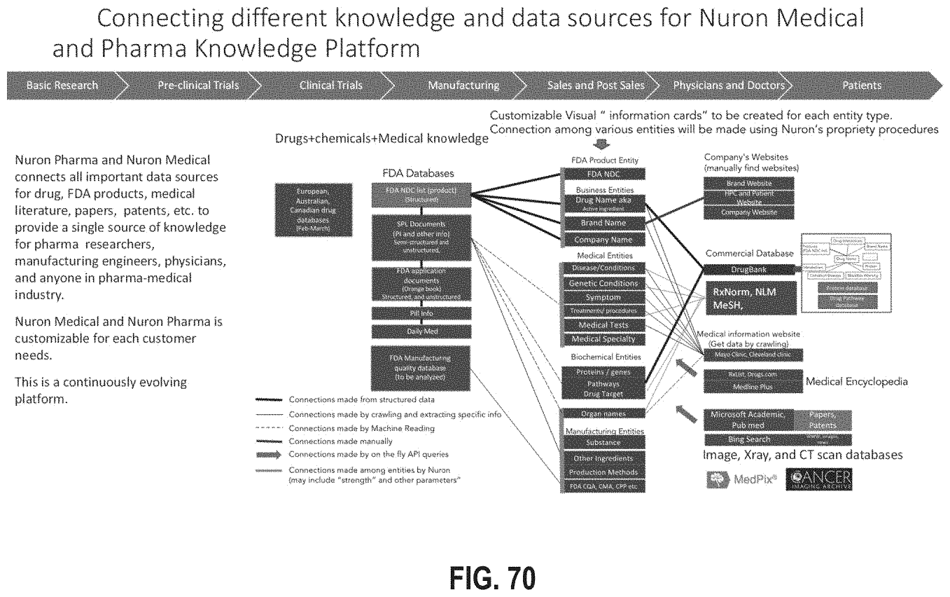

FIG. 70 shows how different public knowledge sources, including structured data, unstructured data, documents, HTML pages images, and videos are (i) combined together, (ii) extract knowledge contents and entities as described in FIGS. 6 to 19, (iii) creation of a medical knowledge graph, and (iv) implementation of various knowledge search and analysis features, in accordance with some embodiments of the present disclosure.

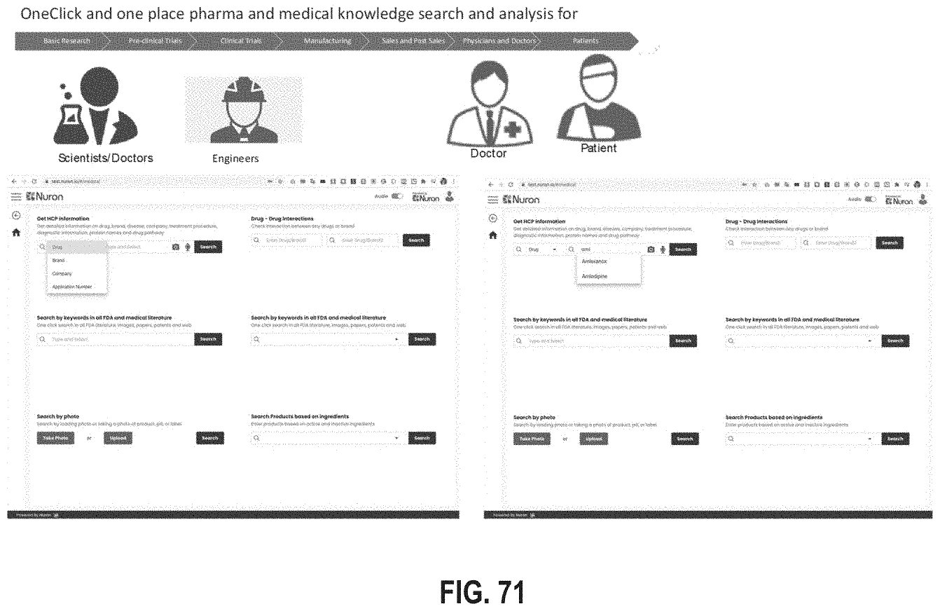

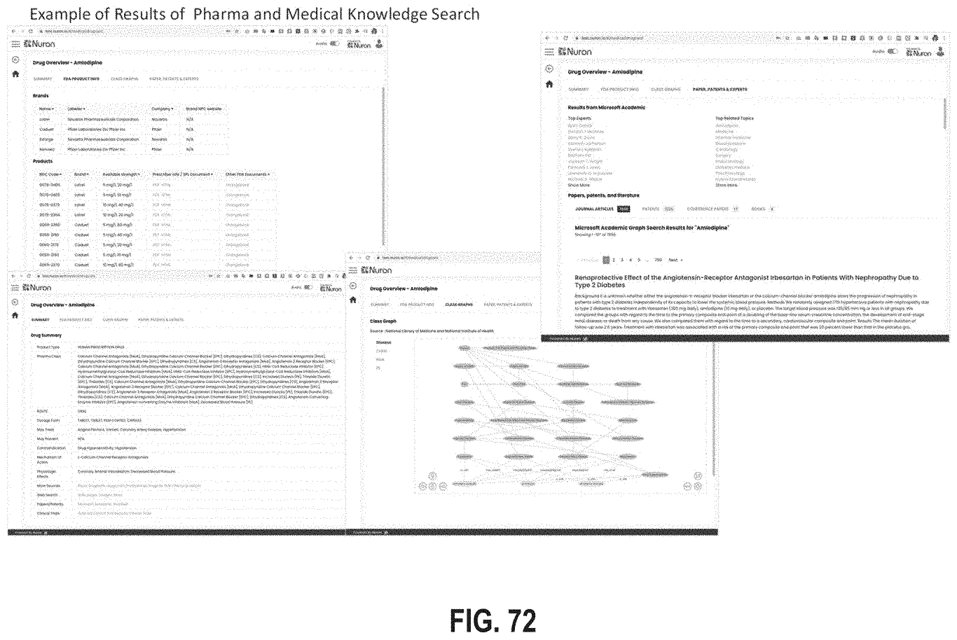

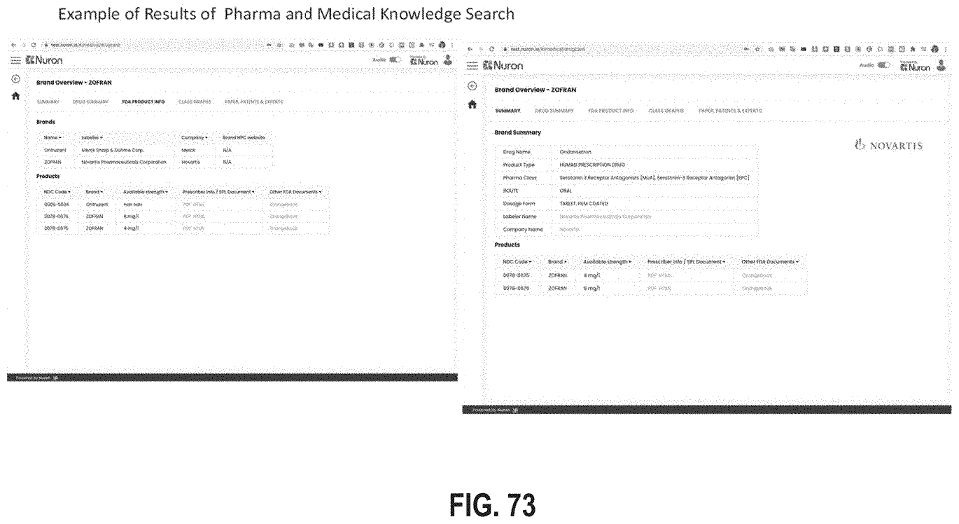

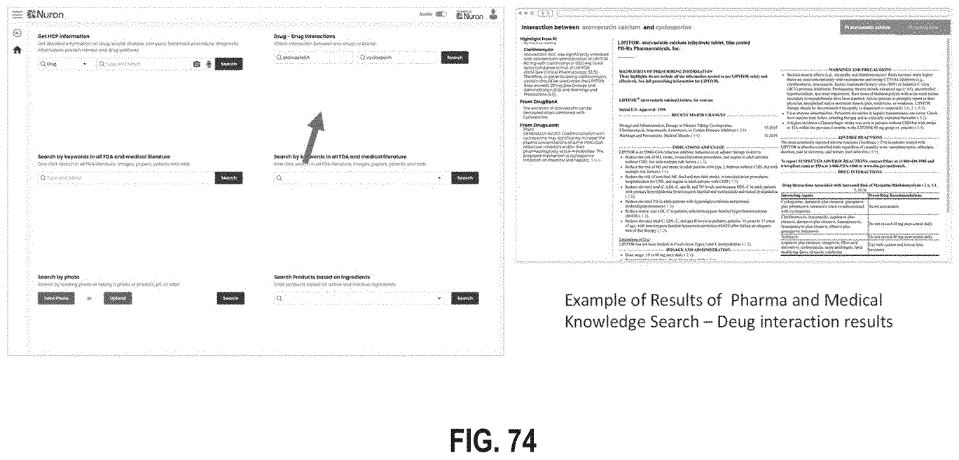

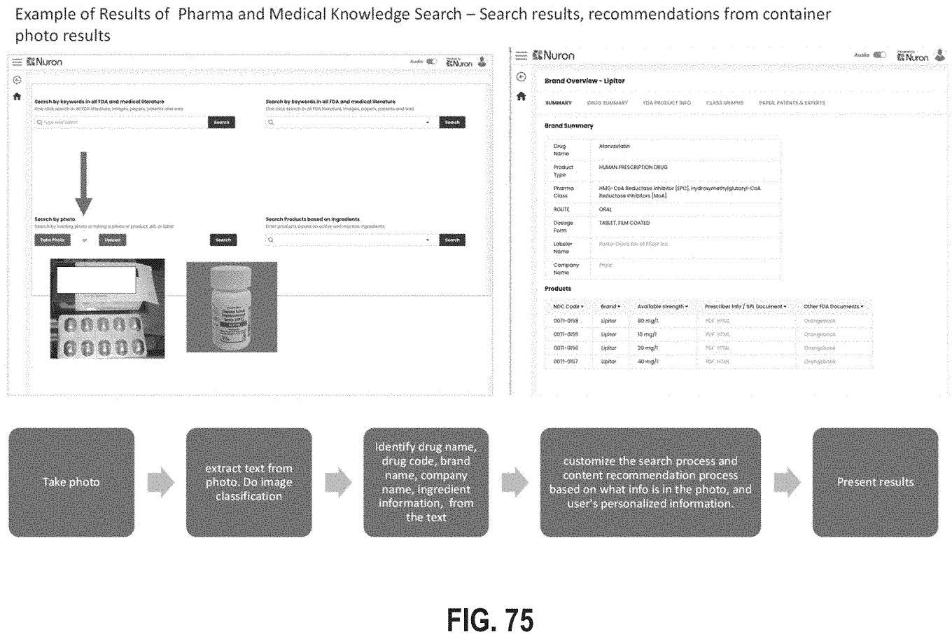

FIGS. 71 to 75 show various types of pharma and medical knowledge searches, in accordance with some embodiments of the present disclosure. Such searches can be done for information relevant to researchers, medical professionals, engineers, salespeople, doctors, etc. FIGS. 72 and 73 show customized information card for a drug and brand. FIG. 74 shows the information about dug-drug integrations obtained from machine reading and knowledge graph of the drugs. FIG. 75 shows how machine vision can be used to provide information about a drug product from the photo of the product taken by the user. FIG. 75 also shows the steps of providing and recommending to the user using various features and capabilities described herein.

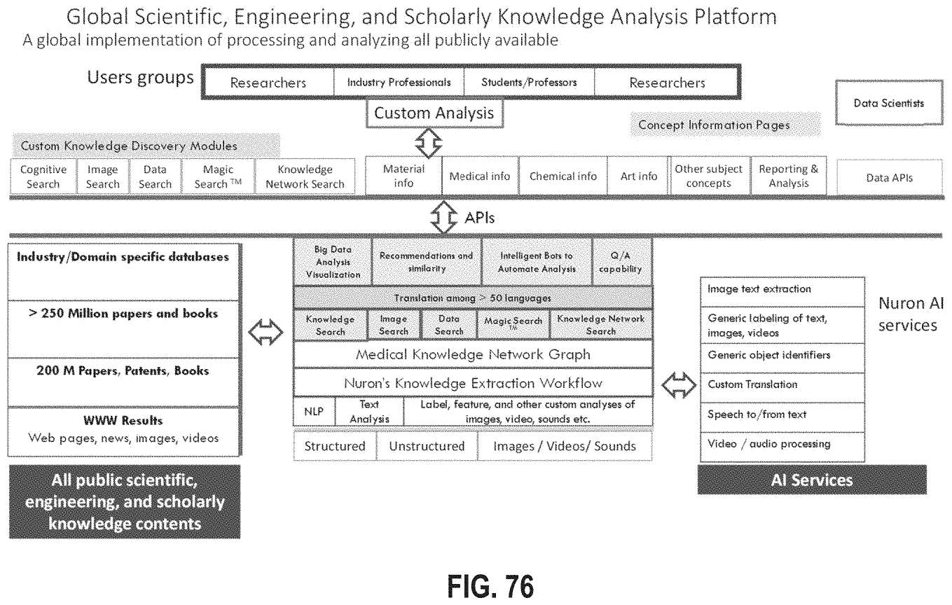

FIG. 76 shows a global scientific and engineering knowledge platform based on the core knowledge search analysis platform, in accordance with some embodiments of the present disclosure. In FIG. 76, shown is receiving and processing knowledge contents from many public papers and patents, receiving and connecting with publicly available information and contents of books, images, video, etc. Such a platform may not be implemented by a web search engine. Only selected data sources can be used for specific domains for information. The contents from each industry domain can be processed according to domains specific processing described herein. The global knowledge platform will be accessible to users to enable multiple ways to enter their knowledge search queries as described herein. Users will get the results in multiple ways (such as shown in FIG. 34).

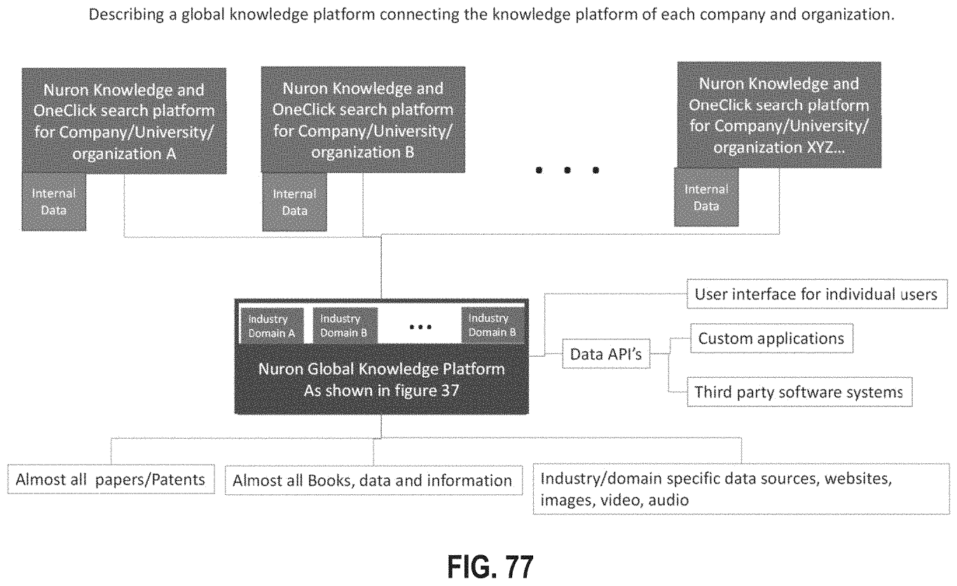

FIG. 77 shows how the global knowledge platform can have multiple knowledge platforms specific to the needs of individual domains, in accordance with some embodiments of the present disclosure. The global knowledge platform and underlying domain specific knowledge platforms can be customized for needs for different domains as well as different text, image, video, audio, data and other types of knowledge extraction and processing for different domains. The global knowledge platform can be connected to an organization's private knowledge platform. The global knowledge platform can also be used to individual consumer focused apps, other third party software systems and platforms, and custom applications.

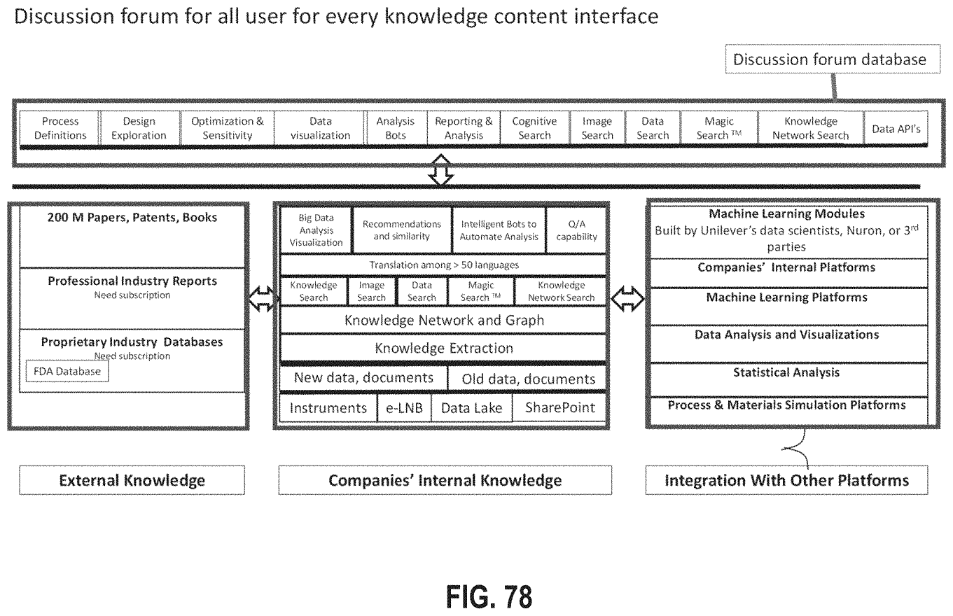

FIG. 78 shows the addition of a discussion feature in the knowledge platform, in accordance with some embodiments of the present disclosure. The discussion feature can allow the users to discuss knowledge contents they have access to.

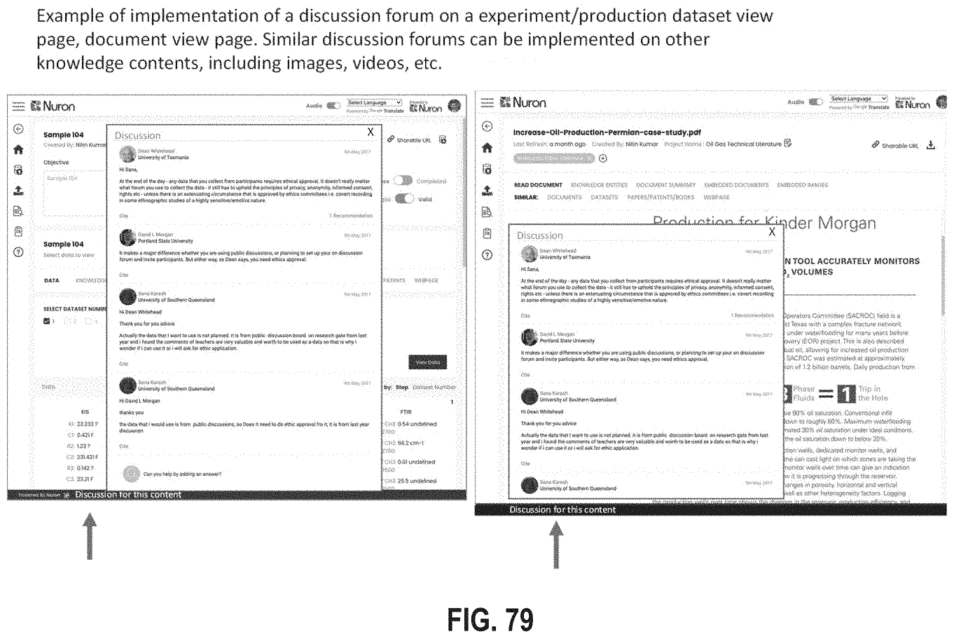

FIG. 79 shows two examples of a discussion forum and feature on a dataset view page and document view page, in accordance with some embodiments of the present disclosure. This can be for experimental data, production and other types of datasets. Also, similar discussion forums can be implemented for other types of knowledge contents.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined desired result. The operations are those requiring physical manipulations of physical quantities. For example, the algorithms described herein can include or be a part of computing systems including hardware and software components of an artificial neural network (ANN) or another type of trainable computing system. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and functionality presented herein are not inherently related to any particular computer or other apparatus. Various general-purpose systems can be used with programs in accordance with the teachings herein, or it can prove convenient to construct a more specialized apparatus to perform the methods described herein. The structure for a variety of these systems will appear as set forth herein. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A computer network, comprising: a plurality of computing devices; and a search engine hosted by a server of the computer network and configured to:
receive, via the computer network, a file or a derivative of the file as input for a search for information stored in the computer network and outside of the computer network; and
perform the search for information using information sources external to the computer network and internal to the computer network,
wherein information to be searched by the search engine comprises scientific information, engineering information, or medical information,
wherein the information to be searched by the search engine comprises private information of a user using the computer network, and
wherein the information to be searched by the search engine is information obtained from a plurality of files comprising scientific information, engineering information, or medical information.

2. The computer network of claim 1, wherein the file is an electronic document file.

3. The computer network of claim 1, wherein the file is an electronic file outputted by an Internet of Things device.

4. The computer network of claim 1, wherein the file is outputted from a database or a database management system.

5. The computer network of claim 1, wherein the file is stored, by a computing system of the computer network, in memory of a cloud computing infrastructure prior to being inputted into the search engine.

6. The computer network of claim 1, wherein the derivative of the file comprises data extracted from the file, and wherein the extraction of the data is performed by a data extraction engine hosted by a second server of the computer network.

7. The computer network of claim 1, wherein the information to be searched is combined, by a computing system of the computer network, in an information storage and retrieval system searchable by the search engine.

8. The computer network of claim 1, wherein the plurality of files is retrieved, by a computing system of the computer network, from sources that are in computer networks internal and external to the computer network.

9. The computer network of claim 1, wherein concepts and knowledge entities are extracted, by a computing system of the computer network, from text within the plurality of files using a language processing and language understanding process.

10. The computer network of claim 1, wherein the derivative of the file comprises data extracted, by a computing system of the computer network, from the file, and wherein at least part of the data extracted from the file is translated, by the computing system of the computer network, from a first language to a second language before being used by the search engine to perform the search.

11. The computer network of claim 1, wherein a result of the search performed by the search engine is a knowledge graph.

12. The computer network of claim 11, wherein a computing system of the computer network is configured to generate an image of the knowledge graph for display in a graphical user interface (GUI).

13. The computer network of claim 1, wherein the search engine is further configured to receive text input.

14. The computer network of claim 13, wherein the search engine is further configured to:
analyze the text input to determine an intent of a user providing the input, prior to performing the search; and
perform the search for information using the information sources external to the computer network and internal to the computer network according to at least the determined intent of the user.

15. The computer network of claim 1, wherein the plurality of files comprise document files, data files, electronic copies of journal articles, electronic copies of patents and patent applications, image files, video files, audio files, and electronic copies of forms of data visualizations including data plots.

16. The computer network of claim 1, wherein the file comprises a mass spectra.

17. The computer network of claim 1, wherein the file comprises a temperature profile.

18. A system, comprising: a plurality of computing devices of a computer network; and
a search engine hosted by at least one of the plurality of computing devices and configured to:
receive, via the computer network, a file or a derivative of the file as input for a search for information stored in the computer network and outside of the computer network; and
perform the search for information using information sources external to the computer network and internal to the computer network,
wherein information to be searched by the search engine comprises scientific information, engineering information, or medical information,
wherein the information to be searched by the search engine comprises private information of a user using the computer network, and
wherein the information to be searched by the search engine is information obtained from a plurality of files comprising scientific information, engineering information, or medical information.

19. A system, comprising: a computer network; and a search engine hosted by the computer network and configured to:
receive, via the computer network, a file or a derivative of the file as input for a search for information stored in the computer network and outside of the computer network; and
perform the search for information using information sources external to the computer network and internal to the computer network,
wherein information to be searched by the search engine comprises scientific information, engineering information, or medical information,
wherein the information to be searched by the search engine comprises private information of a user using the computer network, and
wherein the information to be searched by the search engine is information obtained from a plurality of files comprising scientific information, engineering information, or medical information.

20. The system of claim 19, wherein the derivative of the file comprises data extracted from the file, and wherein the extraction of the data is performed by a data extraction engine hosted by the computer network.
